(19) United States
(12) Patent Application Publication
(10) Pub. No.: US 2008/0262902 A1
(43) Pub. Date: Oct. 23, 2008

(54) SEARCH SYSTEM

(76) Inventors: Wayne Owen Bullis, Cairns (AU); Edward Charles Bullis, Kewarra Beach (AU); Phillip Simon Turton, Clifton Beach (AU); Simon Joseph Turton, Clifton Beach (AU)

Correspondence Address: DICKSTEIN SHAPIRO LLP, 1825 EYE STREET NW, Washington, DC, 20006-5403, US

(21) Appl. No.: 12/105,967

(22) Filed: Apr. 18, 2008

(30) Foreign Application Priority Data
Apr. 19, 2007 (AU) 2007 902055

(51) Int. Cl. G06Q 10/00; G06Q 99/00

(52) U.S. Cl. 705/10; 705/1

(57) ABSTRACT

A profile-based search system for identifying potential matches for a product with one or more buyers, the system including at least one processor configured to: access a product profile representing one or more attributes of a product; access one or more buyer profiles for different buyers, each representing one or more preferences for one of said buyers; generate, based on a comparison of said product profile and said buyer profiles, a selection of one or more of said buyer profiles with preferences that are similar to the attributes defined in said product profile; access, for each said buyer profile in said selection, contact data representing contact details of a representative of said buyer; and generate, based on said contact data, display data representing a user interface including the contact details of said representatives.

### FIELD

The invention relates to profile-based search system, and in particular, but not being limited to, a search system that matches attributes of products with preferences of buyers as defined in respective profiles.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Buyers want to buy products that are suitable for their needs, and will typically approach a vendor of similar or related products for advice. The advice given by such vendors may be limited to the selection of products sold by that vendor, and would rarely include referrals to a better product not provided by that vendor. A similar scenario exists in the real estate industry, where a real estate agency is typically responsible for a portfolio including various properties, but is unaware of (and therefore may not be able to recommend) a more suitable property to a prospective buyer if that property is managed by another agency. In the real estate industry, for example, a problem is that agents would be unwilling to share property listings of their clients if this means that other agents have the ability to contact these clients directly.

Computer systems, such as e-commerce sites, have enabled customer to quickly locate suitable products. These sites are usually suitable for transactions involving small to medium sized consumer goods and do not adequately cater for transactions involving larger items such as ships or real property, for example, due to the greater risk involved. In the later category, it is still important to have an agent to conduct and manage the transaction.

It is therefore desired to address one or more of the above, or to at least provide a useful alternative.

### SUMMARY

To address some of the issues identified above, the present invention provides a computerised system and method with mechanisms for comparing the profiles of buyers (containing buyer preferences) with the profiles of products (containing product attributes) to identify a selection of one or more products which match with most of a buyer's preferences or comes close to the buyer's preferences. Accordingly, the present invention is configured to assist sellers identify potential buyers for their products, based on the buyers' profile or preferences of their stated needs.

Thus, the comparison of buyer profiles with product profiles enables suitable or potential buyers of a particular product to be identified. This is useful, particularly from a vendor's perspective, to assess the demand for a product, particularly for a product which has features that can be compared with other similar products (e.g. real property, cars, etc.). The present invention accordingly can be used to assess market demand, which in turn can be used to assist in determining price.

The present invention can also be configured to assist buyers identify products suited to their needs. However, one problem in current systems is that after a buyer identifies a suitable product, the buyer is not provided with any information to make further enquiries with the seller or the seller's agent. As a result, some sale transactions may not eventuate because buyers may find it too difficult (particularly in an automated or an online environment) to contact a seller to initiate a transaction. One aspect of the present invention attempts to address this by providing contact information of the seller or the seller's agent to the buyer together with details of the product identified as matching the buyer's preferences.

Websites such as www.realestate.com.au provide users with an alert service that sends users personalised email alerts containing property listings which are generated based on user selected preference parameters (e.g. the location by postal code or suburb name, number of rooms and/or price range). Properties that fall within the user's selected preferences are identified as a match, and are included in the email alert sent to the user. If the user's preferences change at a later point in time, the user needs to re-enter the appropriate preference parameters to setup a new alert service. A user is unable to edit or change pre-existing preference selections that are stored as part of a buyer profile on the system. A user is only allowed to delete the stored preferences for an existing alert service. Changing details in a profile is often much quicker and convenient for users, rather than having to re-enter basic details repeated each time a new alert needs to be setup. However, the system available at www.domain.com.au allows users to store preferences for creating a similar email alert, and allows those stored preferences to be edited at a later stage.

An advantage provided by the present invention that is not provided by the above systems is the way in which buyer profiles can be utilised to generate sales leads for a prospective seller of a product (e.g. real property). The above systems do not allow sellers to assess the likely demand for their product.

Furthermore, a problem within the real estate industry is that real estate agents are reluctant to share their property listings with other real estate agents, who may potentially take the sale away from the referring agent. Each real estate agent may service a particular area or region. Because property listings are rarely shared (unless the real estate agents are part of the same agency organisation), buyers are not properly serviced as the agent assisting the buyer will not be aware of a more suitable property matching the buyer's preference located in another area that is not presently on the agent's property listings. This can also serve as a disadvantage to sellers, who are excluded from a potential sale because the seller (or the seller's agent) was not aware of an interested potential buyer. One aspect of the present invention attempts to address this by providing a system that allows sellers to conduct searches based on a product profile to identify matching (or closely matching) buyer profiles. This allows searches to be conducted without limitation by geographic boundaries and without limitation to the extent of a real estate agent's property listing.

The present invention can thus be configured to assist sellers of real estate identify potential buyers. Further, if a buyer is associated with or assisted by an agent, then the present invention can be used to assist a seller identify one or more agents who are likely to best assist in selling the property because such agents have appropriate relationships with likely interested buyers.

A flow on benefit of the present invention is that sharing of property listings is encouraged, which may increase the number of sale transactions conducted. More importantly, the system provides a way of finding an appropriate buyer for a seller's product (and vice versa).

According to the present invention, there is provided a profile-based search system for identifying potential matches for a product with one or more buyers, the system including at least one processor configured to:

i) access a product profile representing one or more attributes of a product;

ii) access one or more buyer profiles for different buyers, each representing one or more preferences for one of said buyers;

iii) generate, based on a comparison of said product profile and said buyer profiles, a selection of one or more of said buyer profiles with preferences that are similar or related to the attributes defined in said product profile;

iv) access, for each said buyer profile in said selection, contact data representing contact details of a representative of said buyer; and

v) generate, based on said contact data, display data representing a user interface including the contact details of said representatives.

The present invention also provides a profile-based search system for identifying potential matches for a buyer with one or more products, the system including at least one processor configured to:

i) access a buyer profile representing one or more preferences of a buyer;

ii) access one or more product profiles for different products, each representing one or more attributes for one of said products;

iii) generate, based on a comparison of said product profile and said buyer profiles, a selection of one or more of said product profiles with attributes that are similar or related to the preferences defined in said product profile;

iv) access, for each said product profile in said selection, contact data representing contact details of a representative of said product; and

v) generate, based on said contact data, display data representing a user interface including the contact details of said representatives.

The present invention also provides a profile-based search method for identifying potential matches for a product with one or more buyers, including:

i) accessing a product profile representing one or more attributes of a product;

ii) accessing one or more buyer profiles for different buyers, each representing one or more preferences for one of said buyers;

iii) generating, based on a comparison of said product profile and said buyer profiles, a selection of one or more of said buyer profiles having preferences that are similar or related to the attributes defined in said product profile;

iv) accessing, for each said buyer profile in said selection, contact data representing contact details of a representative of said buyer; and

v) generating, based on said contact data, display data representing a user interface including the contact details of said representatives.

The present invention also provides a profile-based search method for identifying potential matches for a buyer with one or more products, including:

i) accessing a buyer profile representing one or more preferences of a buyer;

ii) accessing one or more product profiles for different products, each representing one or more attributes for one of said products;

iii) generating, based on a comparison of said product profile and said buyer profiles, a selection of one or more of said product profiles having attributes that are similar or related to the preferences defined in said product profile;

iv) accessing, for each said product profile in said selection, contact data representing contact details of a representative of said product; and

v) generating, based on said contact data, display data representing a user interface including the contact details of said representatives.

### BRIEF DESCRIPTION OF THE DRAWINGS

Preferred embodiment of the present invention are herein described, by way of example only, with reference to the accompanying drawings, wherein:

FIG. 1 is a block diagram showing the components of the search system;

FIG. 2 is an example of a flyer generated by the system;

FIGS. 3 to 20 are examples of user interfaces generated by the system;

FIG. 21 is a product to buyers matching process performed by the system; and

FIG. 22 is a buyer to products matching process performed by the system.

### DETAILED DESCRIPTION OF THE PREFERRED EMBODIMENTS

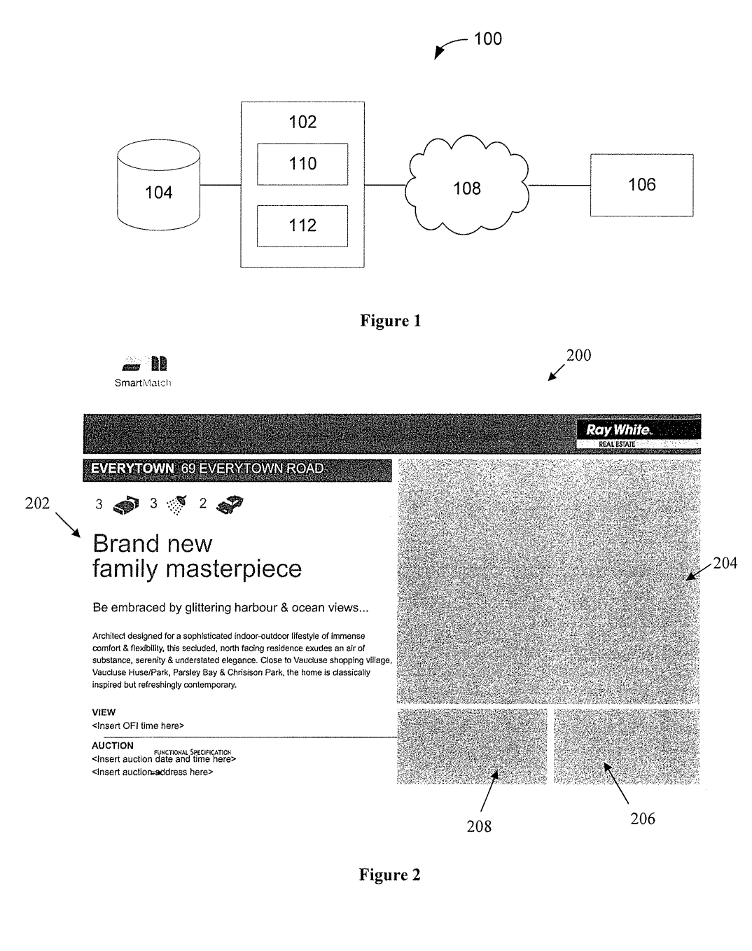

The search system 100 (also referred to as SmartMatch or the SmartMatch system), as shown in FIG. 1, includes a server 102 that communicates with a database 104. The server 102 includes a web server module 110 and a processing module 112, which control the operation of a processor of the server 102 to perform a search process. The server 102 communicates with one or more remote computer terminals 106 via a communications network 108 (such as the Internet or a wireless telecommunications network).

The web server module 110 includes computer program code that configures the server 102 to operate as a web server (e.g. using software such as Apache <www.apache.org>) and the processing module 112 is provided by computer program code in languages such as Java (http://java.sun.com) and Perl (http://www.perl.org). The database 104 is provided by a relational database server such as MySQL (http://www.msql.org), or alternatively, by way of a structured data file (such as in XML), a flat or sequential data file or a combination of one or more of these. The server 102 is a standard personal computer (such as that provided by IBM Corporation <http://www.ibm.com>) running a standard operating system, such as Windows™ or Unix. Those skilled in the art will appreciate that the processes performed by the modules 110 and 112, database 104 and server 102 can also be executed at least in part by dedicated hardware circuits, e.g. Application Specific Integrated Circuits (ASICs) or Field-Programmable Gate Arrays (FPGAs).

A vendor (e.g. the owner of property or its agent) uses one of the remote terminals 106 to provide details or attributes relating to an item (e.g. a piece of real property) into the search system 100 (e.g. via a product data input interface generated by the server 102). The server 102 generates product profile for that property based on these attributes. A potential buyer uses one of the remote terminals 106 to provide details relating to preferences of a product (e.g. real property) that the buyer seeks. The server 102 then generates a buyer profile for that property based on these preferences.

A user uses one of the remote terminals 106 to control the type of searches conducted by the server 102. For example, a user (via a search interface generated by the server 102) controls the processing module 112 to compare one or more buyer profiles with a selected product profile. The processing module 112 identifies a selection of buyer profiles having preference values which substantially match the corresponding attribute values in the selected product profile. In the context of this specification, a match refers to the scenario where a first value has the same value as a second value, including where the first value falls within a predetermined range of values defined in respect of the second value. For example, the processing module 112 identifies a match if at least one of the preference values is the same as (or within a predetermined range from) one of the corresponding attribute values. The processing module 112 then accesses contact data for each of the selected buyer profiles. The contact data represents the contact details of a representative of each buyer (e.g. a real estate agent). The processing module 112 then generates, based on the contact data, a results interface display including the contact details of the buyers' representatives. Similarly, the system 100 may be configured to compare one or more product profiles with a selected buyer profile so that the results interface display generated by the system 100 includes the contact details of the product vendors' representatives.

The search system 100 provides a web-based software solution that can be used to manage a real estate business through one secure web-based application. A core purpose of the system 100 is to demonstrate to a property seller (or vendor) that listing their property with the agent will greatly increase their chance of finding a buyer for their property by matching the property details with buyer profiles. The system 100 also demonstrates to a potential buyer that there are available property listings that match the buyer's profile.

When searching for either property listings or buyer profiles the entire network database (i.e. the collection of one or more buyer profiles and product profiles store on the database 104) is available to search for matches. By capturing details of a property listing and a buyers profile the system 100 provides a single point of data entry for multiple daily business functions within, for example, the real estate environment.

The system 100 preferably allows an agent to print directly to marketing collateral (such as window cards, flyers and newsletters). FIG. 2 provides an example of a flyer 200 that is generated by the system as one type of marketing collateral. The flyer 200 contains information (e.g. text 202 and images 204, 206, 208) that describes an item or property listed in the system 100, and the flyer 200 may include details of an event associated with that item or property (e.g. the date, time, location and agent contact for an auction or inspection time for the item or property). The system also facilitates an automatic upload of property details to the commonly used property websites. In a preferred embodiment, the system 100 generates data files for exporting records (e.g. sales figures or other statistics relating to a buyer, agent, or property) from the database 104 in a format that is readily imported into commonly used trust accounting and finance software packages. For example, the system 100 may generate a Comma Separated Value (CSV) format file that allow direct import into commonly used trust accounting and finance software packages.

When used in the real estate industry context, subscribing to become a user of the system 100 is expected to result in an increase in listings for agencies and will enable an agent to reduce the number of applications required to run their business as well as the amount of data entry required, providing a very real financial, time and resource saving.

The search system 100 allows vendor to buyer as well as buyer to vendor matching, both internally within an agency as well as externally across all other real estate agencies subscribed to the network. This function can be refined as required to either a ‘precise match’ or a ‘close match’ and includes the ability to search surrounding suburbs.

The system 100 can be configured to automatically send e-mail or Short Message Service (SMS) message alerts to the relevant agent when a vendor or buyer match has been short listed. For example, the system 100 generates an immediate e-mail or SMS alert when a property (i.e. product) matching one of the following profiles or reminders is identified:
short listed property profiles;
short listed buyer profiles; and
scheduled appointment or task reminders.

The system 100 includes a module that maintains a calendar, scheduler and e-mail that automatically synchronises to a subscribed user's mobile phone, personal digital assistant (PDA) or other similar device.

Extensive customer database 104 generated by the system 100 captures, stores and archives detailed information. The database 104 captures, stores and archives detailed information that enables the system 100 to provide a comprehensive reporting capability and analysis of the market through statistical analysis of the actual data captured.

Searching capability of the system 100 can be divided into three major categories: (i) residential property for sale or rent, (ii) commercial property for sale or lease, and (iii) vacant land. The system 100 also enables keyword searching based on the text included in description fields of a product profile or buyer profile.

The system 100 also includes a location finder feature, which involves generating a dynamic map of Australia (or regions of Australia), and allows a user to drill down through various subcategories (e.g. state, region, major suburbs or surrounding suburbs) to locate the desired piece of property. The system 100 allows automated upload of data from the system 100 to commonly used property web sites (such as www.domain.com.au or www.realestate.com.au) or on search engines such as Google.

The system 100 includes modules that provide an automated print function to custom templates to produce various marketing materials, including window cards, brochures, flyers and newsletters.

The system 100 includes the ability to perform the following key functions:
Profile searching;
Reference data management;
Agency and user creation and management;
Content publication management;
Stakeholder management; and
Listing management.

These features are described below in greater detail, with reference to its sub-components, relevant data structures associated with each function, and references to relevant screenshots. Desired improvements to functionality are also identified.

### 1. Profile Searching

This function relates to the ability to search listings and match against buyers and buyer profiles. The function can be reached via a listing, or via the Buyer Profile section.

Profile searches can be conducted based on listing details or based on the buyer profile of one or more buyers. For searches conducted based on listing details, a user finds listing and clicks “Profile Search”. User chooses the closeness of the match and then searches to list who comes close. They can then be added to the shortlist for that property. For searches conducted based on buyer profile(s), a user finds a buyer's record and their profiles and then clicks on “Search” and finds listings they are not already shortlisted for that may interest them.

### 2. Reference Data Management

This section outlines the functionality required for maintaining reference data for the system 100. Reference data represents one or more different attributes of a property or item listed in the system 100. Reference data is used throughout the system 100, and preferably also includes agency-specific reference data. The following section outlines the details of each of the functions of the system 100.

The reference data management function involves importing reference data used throughout the system and management facilities to allow the system's 100 administrators to update it. Such reference information includes room features, room types, property features, local authorities, occupancies, tenancies and zones.

Reference data for use by the system 100 is stored in a database, and may be imported from an external data source or database as a first step. This import is considered a one off. For example, the menu item in system 100 “Reference” may include one or more of the following data items relating to a property listing, each of which can be manually entered into the system 100 by a user, or automatically imported into the system 100 (and stored in the database 104):
Listing Type (e.g. Residential, or Commercial property);
Area Unit;
Aspect;
Counts—this shows the range of counts for each feature (below). Min to Max;
Features (number of car spaces, bedroom, bathroom, living area, etc);
Ceiling Type;
Climate Control;
Condition;
Construction Material;
Exterior Constitution;
Fence;

Flooring;
Frontage;
Garage Type;
Insulation;
Land Contour;
Location (e.g. a postcode or ZIP code);
Location Neighbour (e.g. one or more postcodes/ZIP codes adjacent to the Location);
Method of Sale;
Residential Listing Type (rename: Property Type);
Region;
Rental Status;
Residential style;
Roof;
Room Type;
Room Feature;
Sale Status;
State;
Vendor Source; and
View Type.

There could be other data types in the Master Data area (or data source) which can be imported into the system 100. In the case where the data is imported into the system 100, there is no need for a management user interface. The Location (or Location Neighbour) functionality of the system 100 may be implemented by the system 100 using AGIS locality and mapping data (or a mapping service such as Google Earth) and proximity searching to identify listings proximate to a specific predefined location or area nominated by the user.

### 2.1 Reference Data Import

Data exists in the system 100 that will be useful as is for development of more crucial functionality within the system 100. This data will be imported to allow easy access to it. This feature is ONLY available to the system's 100 Administration and System Administrators. Agency users will have no access to import data.

The following is a summary of the workflow for importing data into the system 100:
1. SmartMatch Admin will have access to Administration->Reference Data;
2. Admin will click “Import” menu item to reveal import form;
3. User will pick the data it wishes to import and click “Go”; and
4. Data will be imported into SmartMatch immediately.

Note that it may only be desirable for the import process to be used during development. Once the system is developed and deployed, the old data will be considered obsolete and changes made through the management interfaces described below.

### 2.2 Reference Data Management

Each of the facilities is a standard List/Modify/Delete structure. This should be done using standard FORM posts and may (but does not have to be) implemented using XML remote procedure call (RPC) functions or using Asynchronous JavaScript and XML (AJAX) techniques. Preferably, this feature is ONLY available to SmartMatch Administration and System Administrators. Agency users will have no access to view, edit or delete reference data.

The following is an example of the process for updating the reference data stored in the database 104 of the system 100:
1. SmartMatch Admin will have access to Administration->Reference Data;
2. Listing will show each element that can be edited/added;
3. User clicks the desired reference element and can Add or Update information;
4. User enters the information and clicks “Update”; and
5. Data is saved to the database.

The following is an example of the processing for deleting reference data stored in the database 104 of the system:
1. Smart Match admin views reference data;
2. Clicks “Delete” alongside the relevant piece of reference information;
3. Popup warning “Are you sure you want to delete this item? If it is being used, it will impact the search success of affected properties”; and
4. On clicking OK, set to inactive and hidden from all future search fields, but “ghost” is left as a reference.

Note that the reference data can then be retrieved by queries conducted by the user using the system 100, though this may require manual intervention. Listing I of this specification defines the data table structures that are used by the reference data management feature of the

### 3. Agency and User Creation and Management

This section outlines the functionality for creating and managing the agency and user access for the system 100.

### 3.1 Agency Information and Users

This overriding function controls how real estate agents gain access to the system, and how they and SmartMatch administrators can add user accounts to those agencies.

### 3.2 Agency Creation

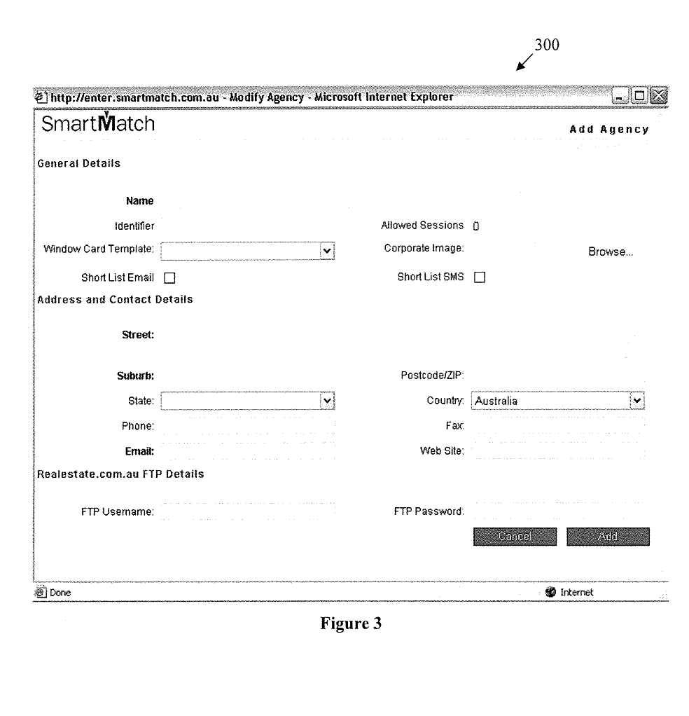

This function concerns creating agencies within the system as they sign up. FIG. 3 is an example of an agency creation user interface 300 of the system 100. The workflow for agency creation is performed by under the control of the system 100 and involves the following steps:
1. Admin will have access to Business Administration->Businesses;
2. Admin will click “Add” icon to popup form with details above;
3. Required fields are highlighted in yellow above; and
4. On Add, business will be created and the system will display the summary tab for that business.

Preferably, the user interface 300 includes other tabs such as:

a) Users (which enables addition/editing/disabling/removing users for this business); and
b) Alliances (including a list of businesses in the system this business is aligned to).

The data tables structures stored in the database 104 and used by the system 100 when performing agency and user creation and management functions are set out in Listing 2.

### 3.3 Agency Listing/Modification/Deletion

This function concerns listing existing agencies, viewing their detail, modifying details and disabling or removing them. Referring to FIG. 3, the workflow for updating an agency listing in the database 104 is performed under the control of the system 100 and involves the following steps:
1. Admin will have access to Business Administration->Businesses;
2. Listing will show business name, Active (tick) or Inactive (cross), Location (Suburb, State);
3. User clicks “Edit” alongside the relevant business, or clicks the Business Name to get a detail view of that business, and then clicks “Edit”;
4. User edits the information and clicks “Update”; and
5. Data is saved to the database 104.

The workflow for deleting an agency listing in the database 104 is performed under the control of the system 100 and involves the following steps:
1 Smart Match admin views list of businesses;
2 Clicks “Active/Inactive” toggle icon alongside business name;
3 Popup warning “Are you sure you want to disable this business? All its users will be immediately unable to access the system. Click OK to continue, or Cancel to abort”
4 Business and its users have bActive set to 0.

It is possible for users of the system 100 to later reactivate an agency listing the same way, for example, by clicking the Inactive icon (a cross) which pops up a message saying “Reactivate this business and its users?”.

### 3.4 Agency User Management

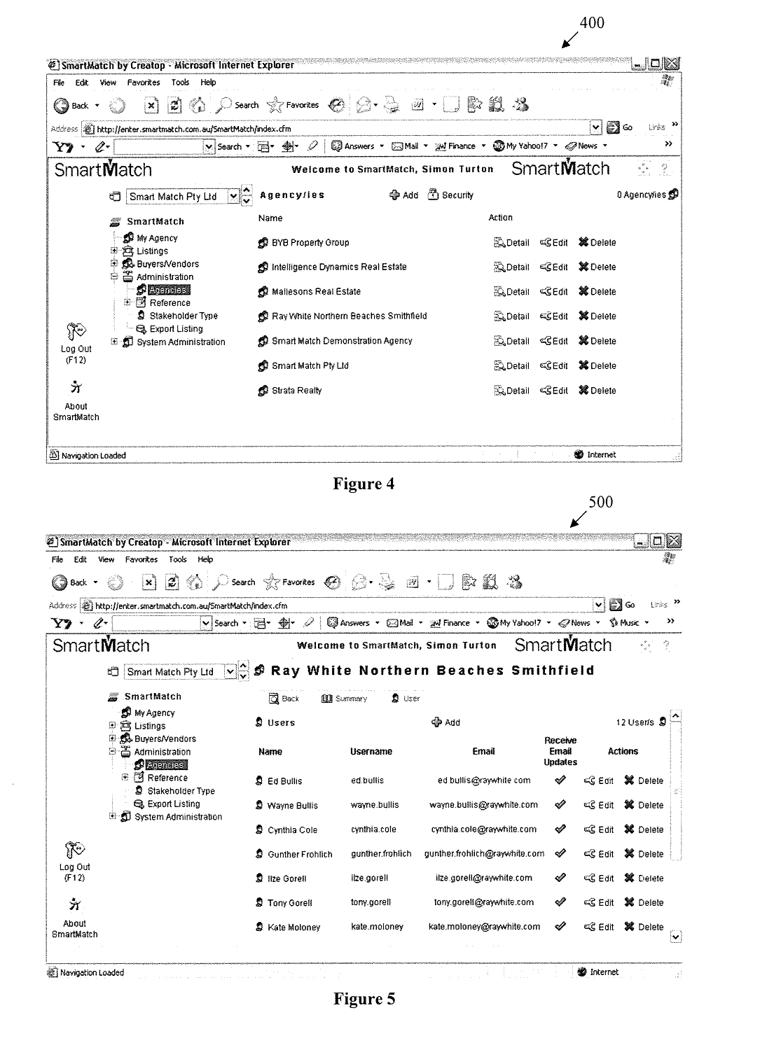

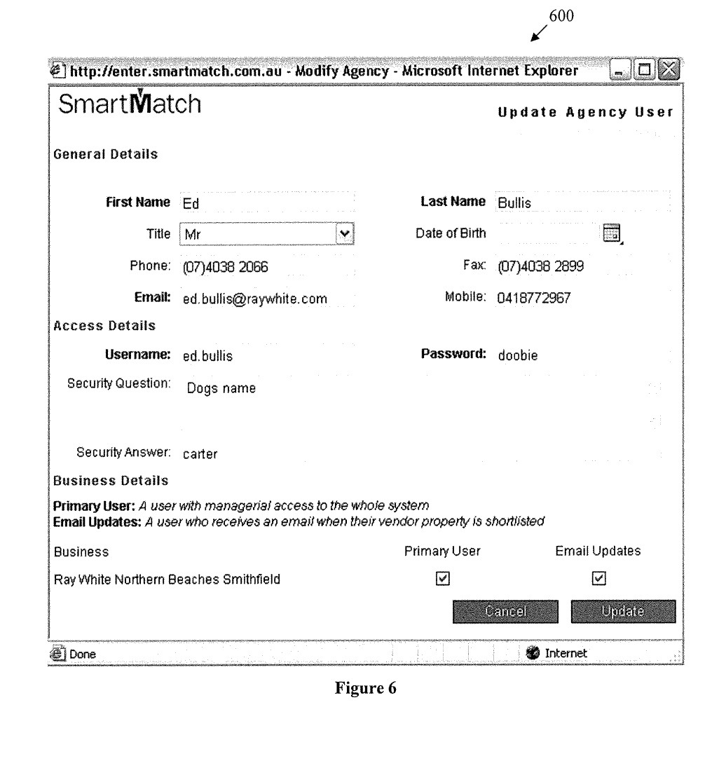

This function concerns how agency users are created and maintained within the system. FIG. 4 is an example of a user interface of the system 100 for displaying agency users of the system 100. For example, an agency user may represent a real estate agency firm. FIG. 5 is an example of a user interface of the system 100 for displaying the one or more individual users associated with a particular agency user (each of which may correspond to a person who is works with or has another relationship with one of the existing agency users). FIG. 6 is a user interface of the system 100 for editing the details associated with a user who is associated with an agency user of the system 100.

The workflow for add or edit user details stored in the database 104 is performed under the control of the system 100 and involves the following steps:
1 Admin clicks on Administration->Businesses;
2 Clicks name of appropriate Business;
3 Clicks “Users” tab;
4 This presents the list of users as per the first screenshot above. The listing in will show Name, Username, Active/Inactive flag, Email address. Actions available are Edit and Delete;
5 To “Edit” an existing user, click the “Edit” icon and fill in the form details; and
6 To “Add” a new user, click “Add” and put in the details.

The system 100 may provide a two-phase user creation:
1 Create the user account; and
2 Link to the business user.

This allows users to be linked to multiple businesses

When viewing business users, it is viewed only in the context of that business. If when adding a user the username exists, a popup should appear which asks “User XXXX exists, click OK to view their details”. If the user views details, they will be given the option to add this user to the business as a user. Details will be added from the table listed below.

Roles are also not handled the same way. A business user will be given default access to the “Business User” role. Additional roles, or groups, can be added to the user by Admin using the system's 100 standard “Security Manager” facility. Password expiry should be checked on login.

The data tables structures used by the system 100 when performing agency user management functions are set out in Listings 3 and 4.

3.5 User login

This function concerns what happens when a user logs in to the system 100. On login, the user will enter the system 100. If the user is linked to multiple businesses, or is a System Admin, they will have a drop down of all agencies they have access for and allow them to switch to view details about each one.

### 4. Content Publication Management

This function allows a user to create the following content based on information input about a listing, such as a window card or a listing website (such as on http://www.realestate.com.au). The purpose of this section is to outline the functionality required for maintaining listings within the system 100.

### 4.1 Data Export

The system 100 enables some of the reference data for a property listing stored in the database 104 to be exported to an external website (or web service). By way of example, two export scenarios will be described with reference to an external website http://www.realestate.com.au.

The workflow for users to take the information within the listing and export it, including photos, to an external website (e.g. realestate.com.au) is conducted under the control of the system 100 and may involve the following steps:
1 SmartMatch user finds appropriate listing in the system and clicks on its name;
2 User clicks “Content” tab;
3 User clicks external website identifier (e.g. “Realestate.com.au” icon) from main screen with list of options;
4 Window pops up. In the background, the system picks up the process files to check the right information is available etc. If it is, it creates the data file to send to realestate.com.au and sends it, otherwise it will report an error saying “Require missing information” and explain to the user what that is; and
5 If it worked, the upload will occur and a message displayed to the user saying it worked or not.

### 4.2 Marketing Collateral Templates

In a preferred embodiment, the user finds the listing and selects the “Content Publication” tab. The user selects “Window Card” from the list of options. A window will popup with the content laid out ready to print and place in the real estate agent's window. The system 100 preferably has the ability to have customised templates surrounding the card. The system 100 may allow a generic template simply showing the Agency's name and logo in a standard location.

This function allows the Agency user to setup templates for their window cards. This workflow is performed under the control by the system 100 and may involve the following:
1 When entering a new listing it validates the information required has been entered and warns the user if not, encouraging them at that point to fix the listing rather than being told later that there is a problem;
2 When generating a Window Card, to do the following:
   a. validate data;
   b. generate window card; and
   c. display it on screen.

There is a range of information required to setup a template for an agency.

The processor file should be formatted to allow a number of actions:
Validate
   a. Pass in ListingID and check if all data is available and suitable.
Generate
   b. Pass in ListingID and run it over the template to create the file.

This same format should be used for a particular external website (e.g. realestate.com.au, domain.com.au) and any other web sites SmartMatch ends up exporting to. The process is the same, the difference would be in “Generate” were it will send the information to the web site's processor.

### 5. Stakeholder Management

This function involves creation of the overall class-handling for stakeholders. This involves making the various stakeholder types and the handling process, which is a method used commonly in the system 100. The stakeholder types identified include: Agent, Vendor, Buyer, Owner, Tenant, and Solicitor. Each has similar information which will be stored in the “Stakeholder” table. This function will handle the default information.

This section outlines the functionality required for maintaining stakeholders of the system 100, and in particular, the functions for adding, editing and deleting of various stakeholder entries stored in the database 104 of the system 100.

### 5.1 Stakeholder Creation and Management

This feature controls the overall structure of stakeholders and the ability to create more, and different types of stakeholders in the future. These functions are based on the SmartPlatform class-based model of dealing with similar types of objects.

The system 100 includes a Stakeholder Types application for creating the various Stakeholder types. This involves the system 100 generating a suitable user interface for populating a StakeholderType data structure as shown in Listing 6. The Stakeholder Types application could be a software module offered together with other system administration features. Preferably, only system administrators are allowed to access the Stakeholder Types application, which serves as a configuration type application, and is not used in general activity for SmartMatch software.

The workflow for adding or updating a stakeholder listing in the database 104 is performed under the control of the system 100 and involves the following steps:
1. System Admin will have access to System Administration->Stakeholder Types;
2. Admin will click “Add” icon to add new type, or “Update” to edit an existing type;
3. Details will be entered and click “Add” or “Update”; and
4. Data will be saved in the database 104.

Apart from StakeholderType data structure shown in Listing 6, another Stakeholder data structure is required, and an example of which is shown in Listing 7. This stores the basic information common to all stakeholders. Listing 8 sets out an example of the files that are used to define and perform stakeholder management functions.

### 5.2 Agency User Management

This relates to functions for adding, editing and deleting (e.g. disable/archive) details of agent entries stored in the database 104 of the system 100. Agents are not to be confused with “Agencies”—these are merely people who act as an agent on behalf of a buyer. Agents do not require any additional information than the standard Stakeholder.

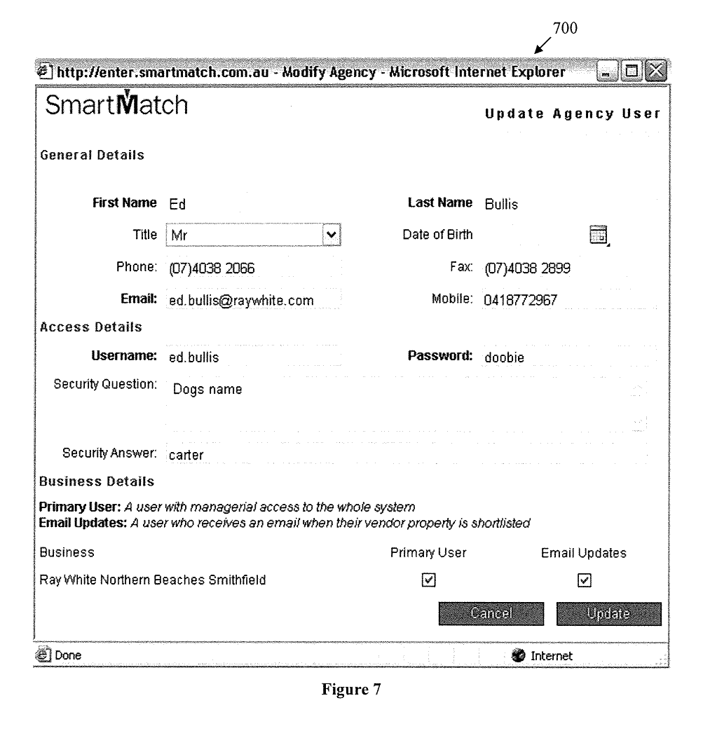

FIG. 7 is an example of a user interface 700 of the system 100 for viewing, adding, editing and deleting Agent details stored in the database 104 of the system 100. The user interface 700 may include a details tab for showing the summary of the information provided (in the user interface of FIG. 7) in read only form. The user interface 700 may further include a drop down/combo box selector within Buyer and Vendor.

### 5.3 Vendor User Management

This relates to functions for adding, editing and deleting (e.g. disable/archive) details of vendor entries stored in the database 104 of the system 100.

These are the vendors linked to properties listed in the system. Vendors require the following additional fields in the Vendor table:
bAgentContact—agent is contact;
AgentID—the linked agent;
VendorSourceID—linked to the VendorSource (see Reference Data spec); and
StakeholderID—linked back to its Stakeholder record.

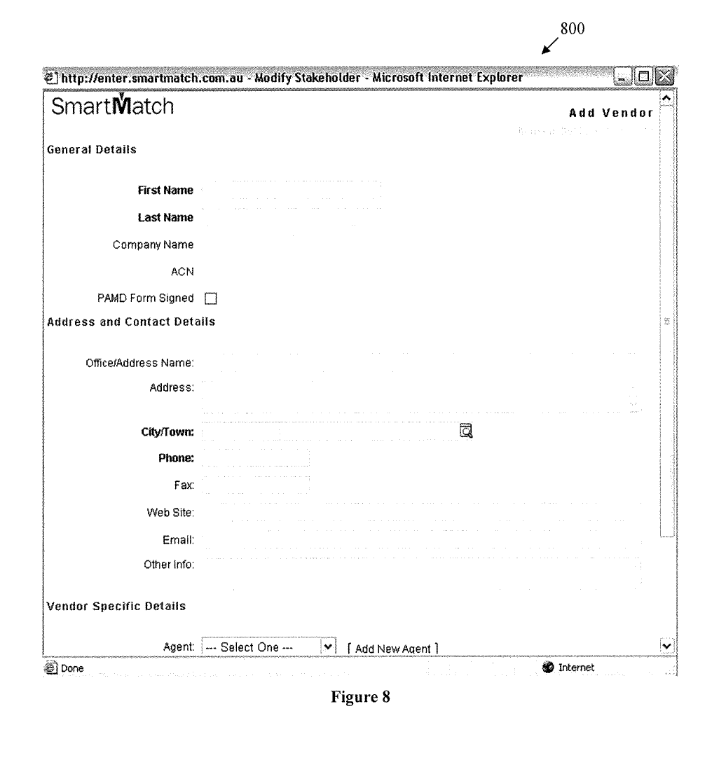

FIG. 8 is an example of a user interface 800 of the system 100 for viewing, adding, editing and deleting Vendor details stored in the database 104 of the system 100. The user interface 800 may include a details tab, which shows the summary of the information provided (in the user interface of FIG. 8) in read only form. The user interface 800 may further include components for showing the listings linked to a particular Vendor. For example, this will show Listing Type, and Listing Identifier, and allow the user to click through to view details of that listing. The user interface 800 may further include a drop down/combo box selector within Property Listing.

### 5.4 Buyer User Management

This relates to functions for adding, editing and deleting (e.g. disable/archive) details of buyer user entries stored in the database 104 of the system 100. The buyers are arguably the most important people in the system—the potential buyers of property. The buyer user management functions also provide buyer users with the ability to setup their profile. Preferably, a buyer profile includes the ability to show the listings that a particular buyer is shortlisted for, and the ability to provide access to profile matching (e.g. with suitable property listings).

Buyers require the following additional fields in the Buyer table:
bPreApprovedFinance—checkbox;
bAgentContact—agent is contact;
AgentID—the linked agent; and
StakeholderID—linked back to its Stakeholder record.

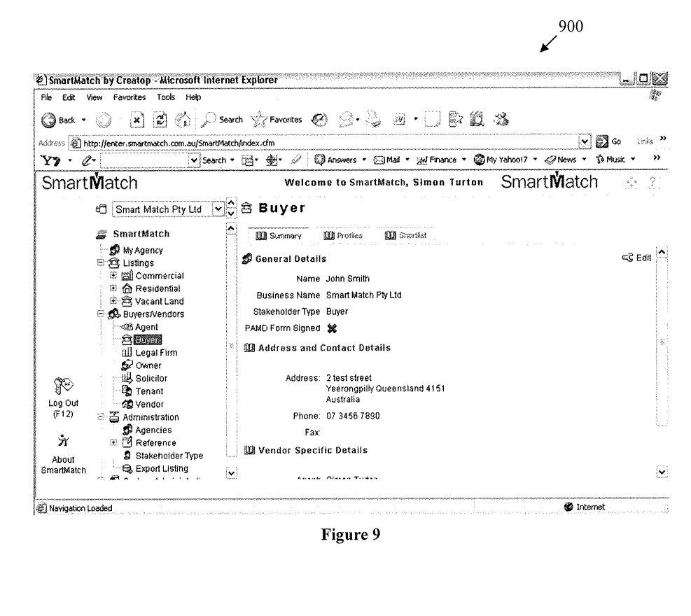

FIG. 9 is an example of a user interface 900 of the system 100 for configuring Buyer user details stored in the database 104 of the system 100. The interface 900 allows a user to:

(i) add, edit, delete (disable/archive) a buyer,
(ii) add, edit, delete a Buyer Profile;
(iii) conduct searches (based on the parameters defined in a Buyer Profile); and
(iv) remove a buyer (or buyer profile) from a selected Shortlist.

The user interface 900 may include the following tabs, which have corresponding functions as described below:
Summary—shows the summary of the above information in read only form;
Profiles—Shows the buyer's profiles stored for searching; and

Shortlist—Shows the property listings this buyer has been shortlisted for.

The user interface 900 may further include a drop down/combo box selector within Property Listing. A user may setup a Buyer Profile by defining parameters (e.g. by selection of checkboxes each representing a predefined characteristic or parameter) representing the user's/buyer's desired features of listings to be able to search properties to potentially shortlist. Listing 9 shows examples of data structures in the database 104 for representing Buyer Profile information.

### 5.5 Owner/Vendor User Management

This relates to functions for adding, editing and deleting (e.g. disable/archive) details of owner user entries stored in the database 104 of the system 100. These functions may also provide the ability to display details about property owners/vendors. Owners do not require additional information.

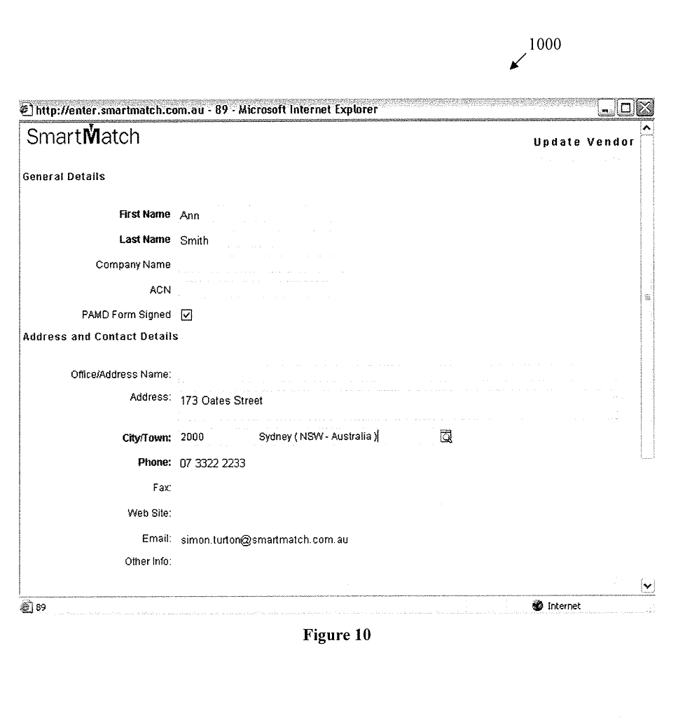

FIG. 10 is an example of a user interface 1000 of the system 100 for adding, editing and deleting Owner/Vendor details stored in the database 104. The user interface 1000 preferably includes a summary tab for showing the summary of the above information in read only form. The user interface 1000 may further include a drop down/combo box selector within Property Listing (e.g. for Rental property listings only).

### 5.6 Legal Firm User Management

This relates to functions for adding, editing and deleting (e.g. disable/archive) details of Legal firm user entries stored in the database 104 of the system 100.

Legal firms users require no other information to that of a regular user. However, the Legal

Firm name should be stored in “tFullName”, not as a split first/last name combination.

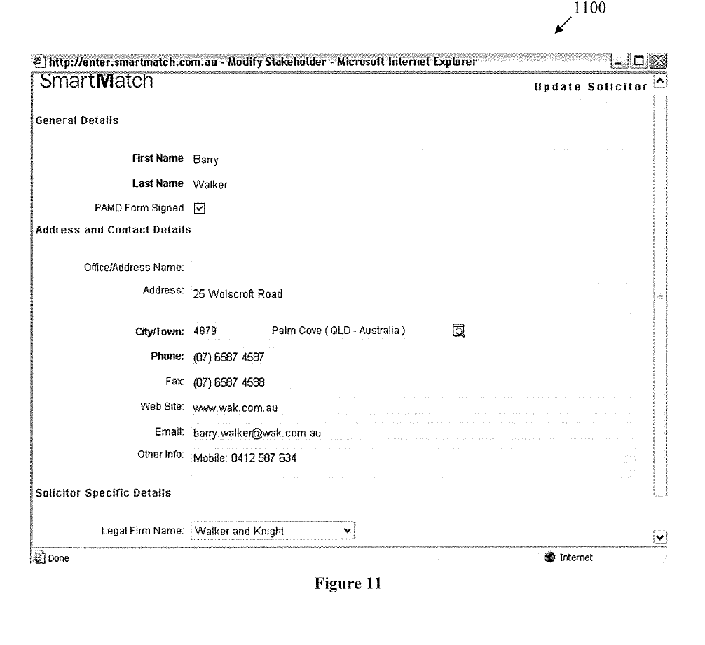

FIG. 11 is an example of a user interface 1100 of the system 100 for configuring Legal firm user details stored in the database 104 of the system 100. The interface 1100 allows a user to:

(i) add, edit, delete (disable/archive) a legal firm user; and
(ii) add, edit, delete and view solicitor users associated with a particular legal firm user.

The user interface 1100 may include the following tabs, which have corresponding functions as described below:
Summary—shows the summary of the above information in read only form; and
Solicitors—list the solicitors within this firm.

The user interface 1100 may further include a drop down/combo box selector within Solicitor

### 5.7 Solicitor User Management

This relates to functions for adding, editing and deleting (e.g. disable/archive) details of solicitors who are part of a Legal firm user.

The following information should be stored in the Solicitor table:
StakeholderID—its stakeholder record; and
LegalFirmID—StakeholderID of its parent Legal Firm.

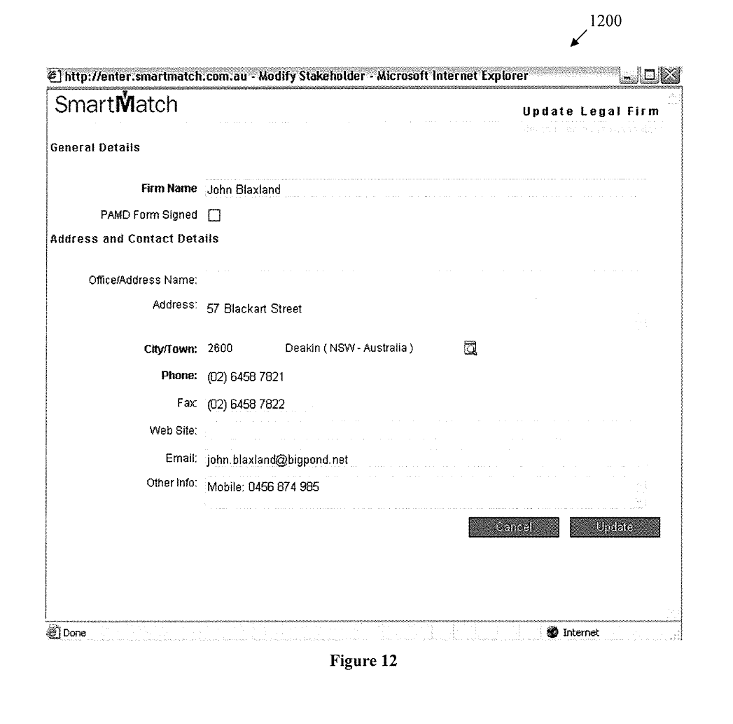

FIG. 12 is an example of a user interface 1200 of the system 100 for configuring Solicitor user details stored in the database 104 of the system 100. The interface 1200 preferably includes a summary tab for showing a summary of the above information in read only form. The interface 1200 may further include a drop down/combo box selector within property listing.

### 5.8 Tenant User Management

This relates to functions for adding, editing and deleting (e.g. disable/archive) details of Tenant users, who are part of a stakeholder identity firm.

The following information should be stored in the Tenant table:
StakeholderID—its stakeholder record; and
AgentID—StakeholderID of its AgentID.

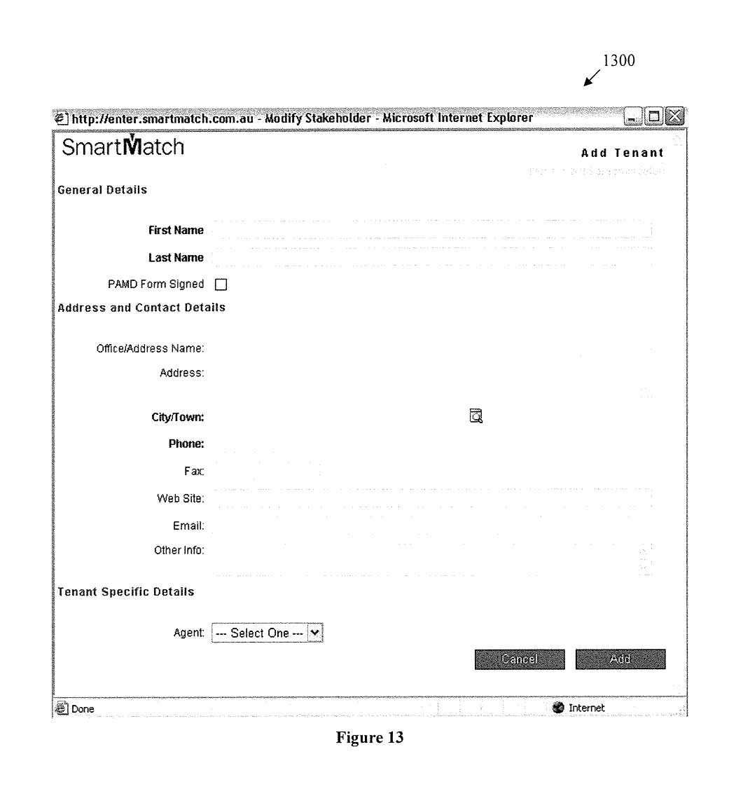

FIG. 13 is an example of a user interface 1300 of the system for configuring Tenant user details stored in the database 104 of the system 100. The interface 1300 preferable includes the following tabs, which have corresponding functions as defined below:
Summary—shows the summary of the above information in read only form; and
Tenancies—shows their current and past tenancies with this agency. This links to a Rental Property Listing of status “Leased”.

The interface 1300 may further include a drop down/combo box selector within property listing tenancy for rental property type.

### 6. Listing Management

This function concerns viewing and entering information about listings—e.g. for commercial and residential properties. This includes, for example, means for generating the listing and detail pages, and an ability for the agent to do basic filtering on current/past listings, filter by listing type and sale type (rental, purchase) etc. This section outlines the details of each of the listing management functions of the system 100.

### 6.1 Listing Management Features

This feature controls the overall structure of listings and the ability to create more, and different types of listings in the future. This is based on the SmartPlatform class-based model of dealing with similar types of objects. Listing 10 is an example of a data structure in the database 104 for storing data representing listing types.

The workflow for updating an agency listing in the database 104 is performed under the control of the system 100 and involves the following steps:
1. System Admin will have access to System Administration->Listing Types;
2. Admin will click “Add” icon to add new type, or “Update” to edit an existing type;
3. Details will be entered and click “Add” or “Update”; and
4. Data will be saved.

Listing 11 provides an example of the types of files used to provide the listing management functionality.

### 6.2 Add/Modify Listing

This function allows a user to add or modify a listing, if they are permissioned to do so. The workflow for adding a listing is different to editing, in order to make it as simple as possible to upload all necessary information. The focus being to ensure as much information is available to print a window card or export to a real estate web site as possible.

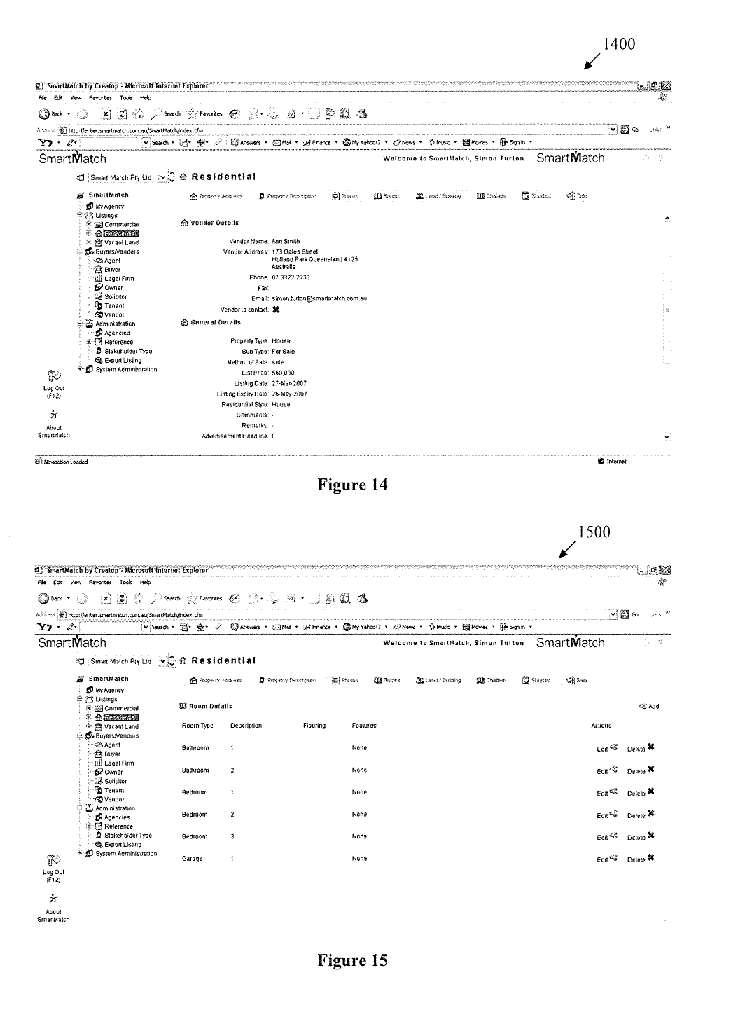

FIG. 14 is an example of a client management user interface 1400 of the system that provides several function tabs for a user.

The workflow for adding a listing to the database 104 is performed under the control of the system 100 and involves the following steps:
1 SmartMatch user clicks “Add Listing” either from a listing type screen (eg from viewing Residential Listings) or from the overall listing page and having chosen the type from a drop down (eg Residential, Commercial, Vacant Land);
2 Specify Listing Sub-type—Rental/Lease, For Sale, Share Accommodation depending on the type. Screen automatically goes to the data entry screen which has data tailored based on the listing type;
3 User enters all required fields and clicks “Add”;
4 This creates the listing record, and then refreshes to present a screen allowing the user to upload photos of the property. They have a choice to either upload a ZIP file which contains many photos of the property, OR they can keep selecting files from their local computer by clicking “Browse”;
5 Once they have selected all files/zip, they click “Upload” and the files get uploaded against the listing;
6 Thumbnails of uploaded images are displayed and the user is given the option to select whether they should be used for window cards. The means for this will be determined based on formats of the window cards; and
7 The form will then close and present a detailed listing of what's been entered and allow the user to review and add more detail as desired, or immediately print a Window Card or create export to an external website (e.g. RealEstate.com.au).

The workflow for modifying a listing to the database 104 is performed under the control of the system 100 and involves the following steps:
1 SmartMatch user finds the listing in the usual manner by searching through the listings. They click “View” or the address of the listing to get more details;
2 User clicks on the relevant tab and clicks “Edit” alongside the information they wish to change;
3 User changes the information and clicks “Update”; and
4 Changes are saved in the database 104.

The workflow for deleting a listing to the database 104 is performed under the control of the system 100 and involves the following steps:
1 SmartMatch user finds the listing they wish to remove;
2 User clicks “Delete” alongside the relevant listing and when asked “Are you sure” clicks “OK”; and
3 bActive is set to 0 and the listing disappears from view, but is still stored in the database for retrieval.

Listing 12 provides an example of several data structures stored in the database 104 for representing listing data corresponding to a property or item listed in the system 100.

### 6.3 Listing Photos

This function allows a SmartMatch user to upload/remove/change photos within the listing. The workflow for manage listing photos in the database 104 is performed under the control of the system 100 and involves the following steps:
1 SmartMatch user finds appropriate listing and clicks its name;
2 User clicks “Photos” tab to view current photos; and
3 User can click “Edit” alongside existing photo to change it or its caption; or user can click “Delete” to remove the photo; or user can click “Add” to upload a new photo.

### 6.4 Listing Rooms

This function allows a SmartMatch user to add/edit/delete information about rooms within the listing, including their features (Air conditioning etc). The workflow for managing listing rooms in the database 104 is performed under the control of the system 100 and involves the following steps:
1 SmartMatch user finds appropriate listing and clicks its name;
2 User clicks “Rooms” tab to view current rooms;
3 User can click “Edit” alongside room to edit its details; OR User can click checkbox alongside a number of rooms and click “Edit” to edit multiple rooms at once;
4 User can click “Add” to add room details not previously listed; and
5 User can click “Delete” to remove a room from a listing.

FIG. 15 is an example of a user interface 1500 of the system 100 for creating and editing details of different rooms associated with a listing in the system 100.

### 6.5 Land and Building

This function allows a SmartMatch user to add/edit/delete information about land area, buildings, lot numbers etc. The workflow for this function is performed under the control of the system 100 and involves the following steps:
1. SmartMatch user finds appropriate listing and clicks its name;
2. User clicks “Land and Building” tab to view current details; and
3. User clicks “Edit” to change the details and clicks “Update” to save changes to the database 104.

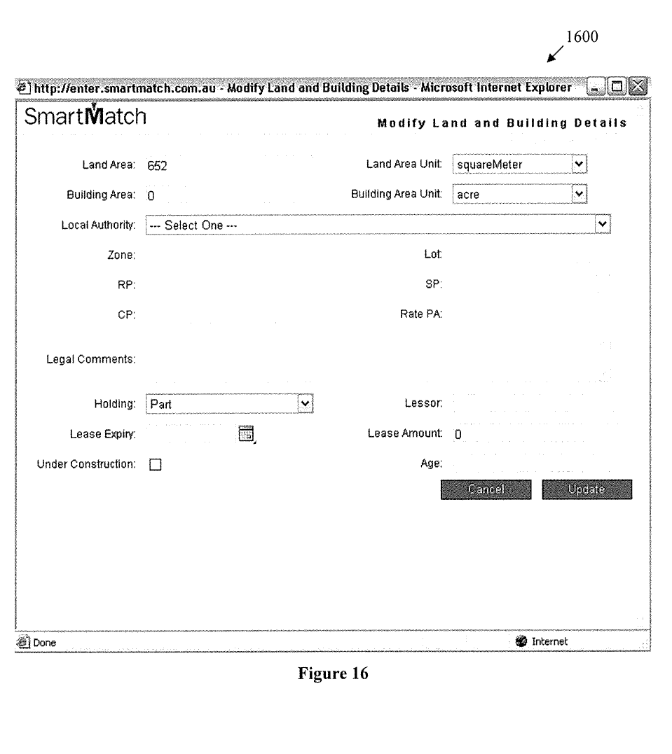

FIG. 16 is an example of a user interface 1600 of the system 100 for managing land and building details associated with a listing in the system 100.

### 6.6 Chattels

This function allows a SmartMatch user to add/edit/delete chattel details about a property. The workflow for this function is performed under the control of the system 100 and involves the following steps:
1. SmartMatch user finds appropriate listing and clicks its name;
2. User clicks “Chattels” tab to view current chattels details; and
3. User clicks “Edit” to change the details and clicks “Update” to save changes to the database 104.

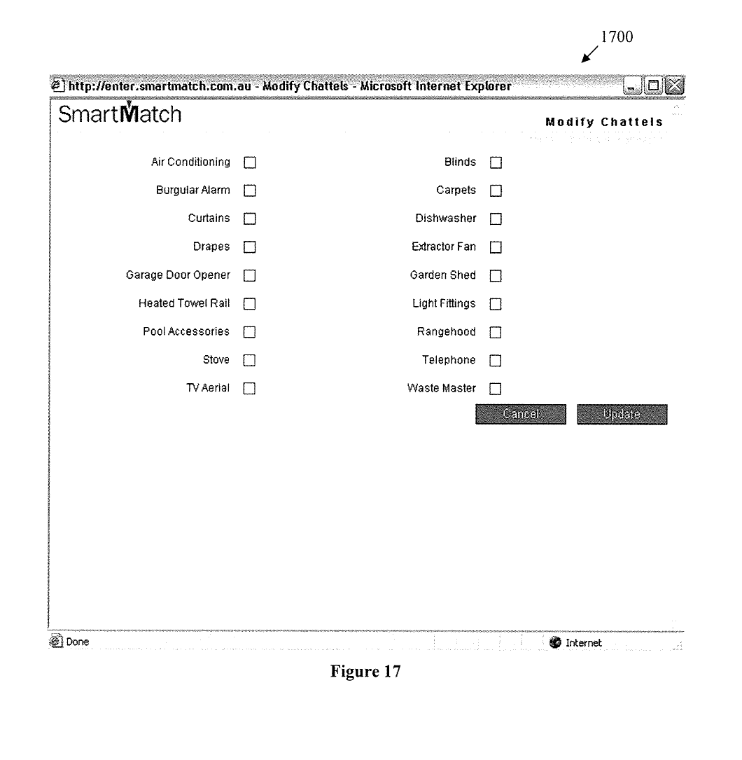

FIG. 17 is an example of a user interface 1700 of the system 100 for managing chattels details associated with a listing in the system 100.

### 6.7 Advertisement

This function allows a SmartMatch user to add/edit/delete advertisements relating to a property. The workflow for this function is performed under the control of the system 100 and involves the following steps:
1. SmartMatch user finds appropriate listing and clicks its name;
2. User clicks “Comments” tab to view current details; and
3. User clicks “Edit” to change the details and clicks “Next” to save changes to the database 104.

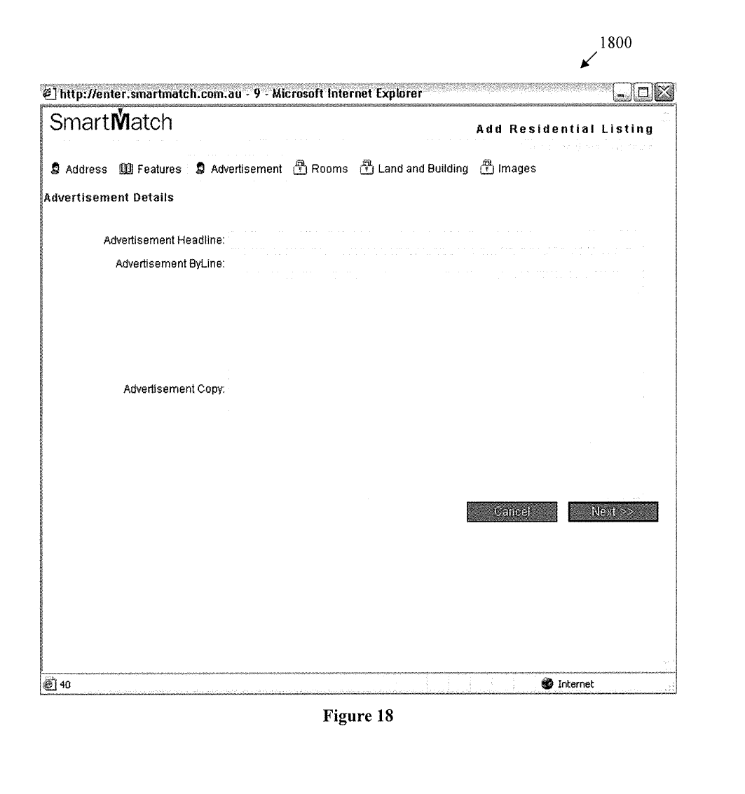

FIG. 18 is an example of a user interface 1800 of the system 100 for managing advertisement details associated with a listing in the system 100.

### 6.8 Sale Details

This function allows a SmartMatch user to add/edit/delete details about the sale of the property (only applies to sales, not rentals). The workflow for this function is performed under the control of the system 100 and involves the following steps:
1. SmartMatch user finds appropriate listing and clicks its name;
2. User clicks “Sales” tab to view current details; and
3. User clicks “Edit” to change the details and clicks “Update” to save changes to the database 104.

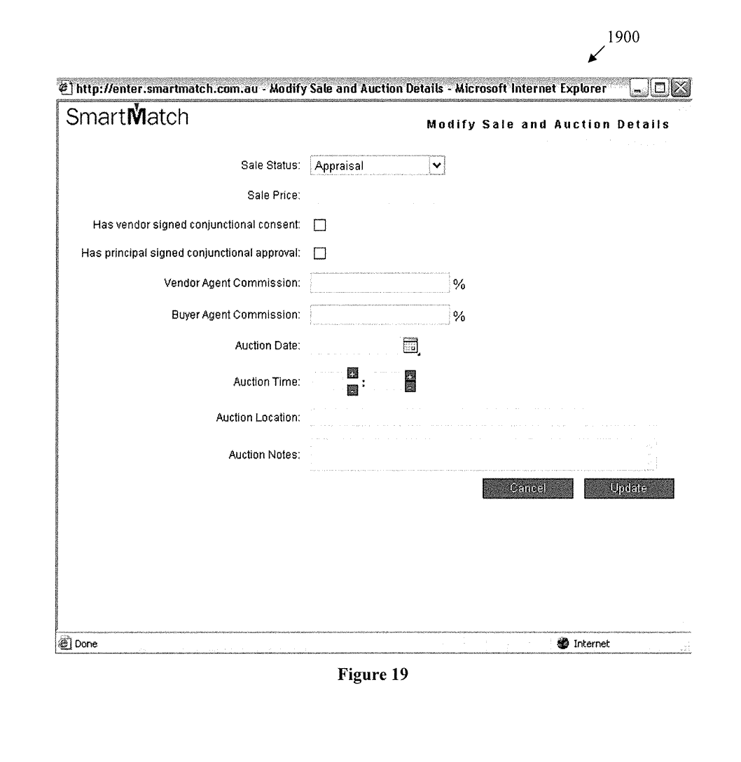

FIG. 19 is an example of a user interface 1900 of the system 100 for managing sales details associated with a listing in the system 100.

### 6.9 Shortlist Details

This function shows the short list of potential buyers for the property, and allows the SmartMatch user to search for more, or remove existing ones. The workflow for this function is performed under the control of the system 100 and involves the following steps:
1. SmartMatch user finds appropriate listing and clicks its name;
2. User clicks “Shortlist” tab to view current details of short listed buyers and profiles; and
3. User clicks “Edit” alongside existing shortlist entry to modify details; “Add” to add a profile manually to the shortlist (for example, someone off the street says they are interested without going through the profile matching process); or “Delete” to remove them from the shortlist (this will set their shortlisting to inactive, they will still have a historical record as being shortlisted for the property).

The SmartMatch user can also search for matching profiles by clicking the “Search” icon, after choosing the level of search from the drop down box—0=Perfect Match, 10=Close Match

The algorithm for this profile matching comes from the system. The Stored Procedure code and thus profile matching logic is described in the Profile Searching section of this specification

On searching, a list of buyers and profiles will be presented who have not already been shortlisted. The SmartMatch user will be able to click a checkbox alongside one or more of the listed profiles and click “Add to Shortlist” to add them.

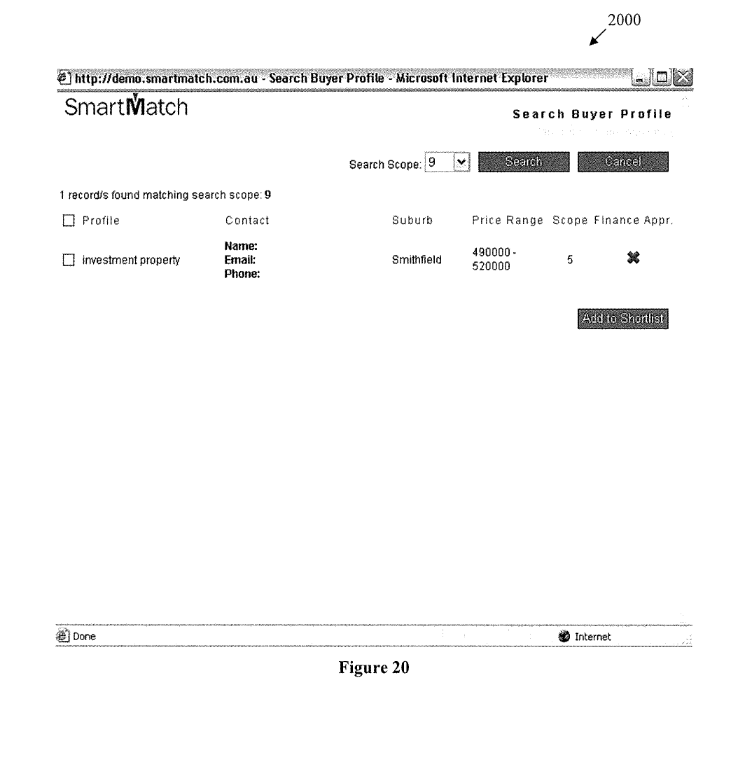

FIG. 20 is an example of a user interface 2000 of the system 100 for managing shortlist details associated with a listing in the system 100.

### 7. Profile Searching

The following section outlines the profile searching functions of the system 100.

The system 100 includes modules that set up the basic algorithms for matching profiles with listings. There are two methods for searching listings or profile data in the system 100:
by Listing; or
by Profile.

In order to make the process flexible and usable in other facilities, it is preferably a ColdFusion Component (CFC). The system 100 allows it to be run simply by passing some independent parameters into the system and retrieve a listing of matching IDs.

It may be possible to make the CFCs available via a web service and thus make searching possible from agencies' own web sites and other plugins.

### CFC: SearchProfileByListing

### Input Parameters:

1 ListingID—takes in a single ListingID to search
2 nSearchAccuracy—0 (perfect match) to 10 (close match)
   Returns: Query object containing BuyerProfileID, nMatchPercentage

### CFC: SearchListingsByProfile

### Input Parameters:

1 BuyerProfileID—takes in a single BuyerProfile to search
2 nSearchAccuracy—0 (perfect match) to 10 (close match)
   Returns: Query Object containing ListingID, nMatchPercentage

Code from the profile searching module of the system 100 will form the basis for conducting searches based on listing details or profile details. For example, the profile searching module may incorporate code written as TransactSQL stored procedures in SQL Server.

### 7.1 Profile Search by Listing

This function allows the user to search for buyer profiles from a given listing. The workflow for this function is performed under the control of the system 100 and involves the following steps:
1 SmartMatch user finds the appropriate listing in the Listings area of the system;
2 User clicks on “Profile Search” tab. This opens the Short List tab on the main window and pops up the Profile Search screen;
3 User selects the closeness of the search matching and then clicks “Search”;
4 SmartMatch will display a list of matching BuyerProfiles, ordered by closeness of the match, with a checkbox alongside, excluding any profiles already shortlisted;
5 User can click individual profiles' checkboxes, or can click the “Select all” button at bottom of screen;
6 User clicks “Add to Shortlist” and the profiles are added to the listing's shortlist, and the shortlist is updated to reflect this; and
7 Email is sent to Listing Contact (either Vendor or their nominated contact) saying:
   Subject: Property [PropertyName] has been shortlisted. A buyer has been shortlisted to your property by agent [AgentName] of [AgencyName]. Contact them on [PhoneNumber] if you wish for this buyer to be given details of your property.

This email should be sent to the vendor/contact of this listing only once, and only if one or more buyer profiles were added to the shortlist.

### 7.2 Profile Search by Buyer Profile

This function allows a SmartMatch user to search for matching properties from a buyer's profile. The workflow for this function is performed under the control of the system 100 and involves the following steps:
1 SmartMatch user finds appropriate buyer and clicks “Buyer Profile” tab;
2 User clicks “Search” alongside relevant profile;
3 User selects the closeness of the search matching and then clicks “Search”;
4 SmartMatch will display a list of matching Listings, ordered by closeness of the match, with a checkbox alongside, excluding any listings already shortlisted;
5 User can click individual listings' checkboxes, or can click the “Select all” button at bottom of screen;
6 User clicks “Add to Shortlist” and the listings are added to the buyer's profile of shortlisted properties, and the shortlist is updated and viewed to reflect this; and
7 Email is sent to Listing Contact (either Vendor or their nominated contact) saying: Subject: [ListingName] Has Been Shortlisted. Your property has been shortlisted to a buyer profile by agent [AgentName] of [AgencyName]. Contact them on [PhoneNumber] if you wish for this buyer to be given details of your property.

This email should be sent to the vendor/contact of each listing added to the buyer's profile.

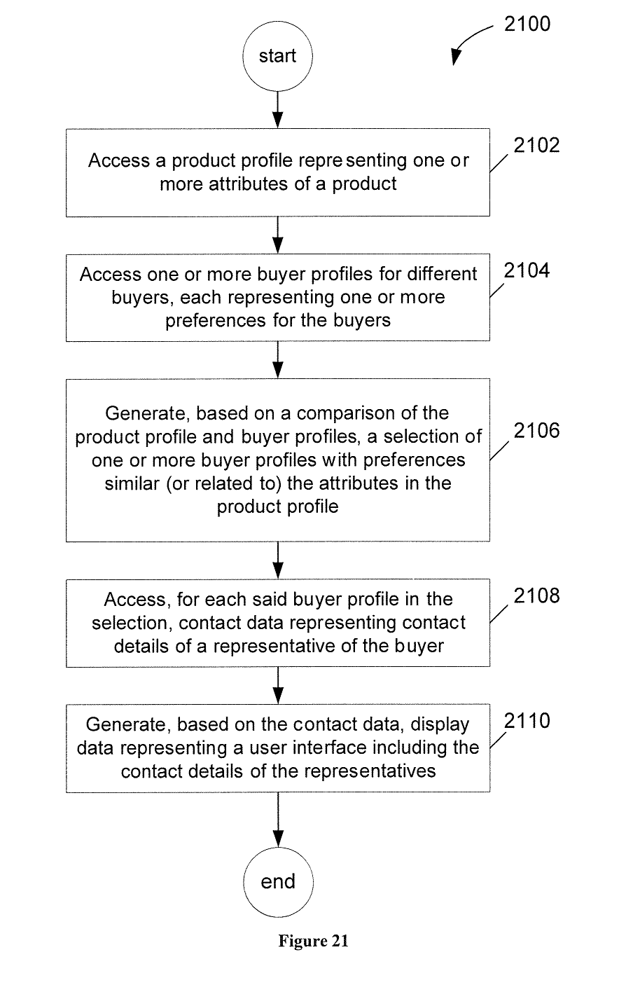

FIG. 21 shows a product to buyers matching process 2100 performed by the processing module 112 under the control of the system 100. The process 2100 identifies potential matches for a product with one or more buyers, and begins at step 2102 by the processing module 112 accessing a product profile representing one or more attributes of a product. Product profiles are stored in the database 104 and a product profile may, for example, include any of the attributes defined in the listings data as shown in Listing 12.

At step 2104, the processing module 112 accesses one or more buyer profiles for different buyers, each representing one or more preferences for one of the buyers. Buyer profiles are stored in the database 104 and a buyer profile may, for example, include any of the preferences defined in the buyer user data as shown in Listing 9.

At step 2106, the processing module 112 generates, based on a comparison of the product profile and the buyer profiles, a selection of one or more of the buyer profiles with preferences that are similar (or related to) to the attributes defined in said product profile. For example, a match may be identified if there is an exact match in the value of a corresponding preference and attribute parameter in the buyer and product profiles respectively (or where there is no exact match but the value of the preference parameter of the buyer profile falls within a predefined range of the value of the attribute parameter of the product profile).

At step 2108, the processing module 112 accesses, for each buyer profile in said selection, contact data representing contact details of a representative of said buyer. A representative includes an agent (e.g. a real estate agent if the product relates to real property) who is nominated to act or correspond with others on the buyer's behalf. Contact details are stored in the database 104 and may include a telephone number, email and address.

At step 2110, the processing module 112 generates, based on the contact data, display data representing a user interface (for display to the user) including the contact details of the representatives. This enables a user to make contact with the representative of the buyer to initiate a transaction with the buyer in respect of the product. Process 2100 ends after step 2110.

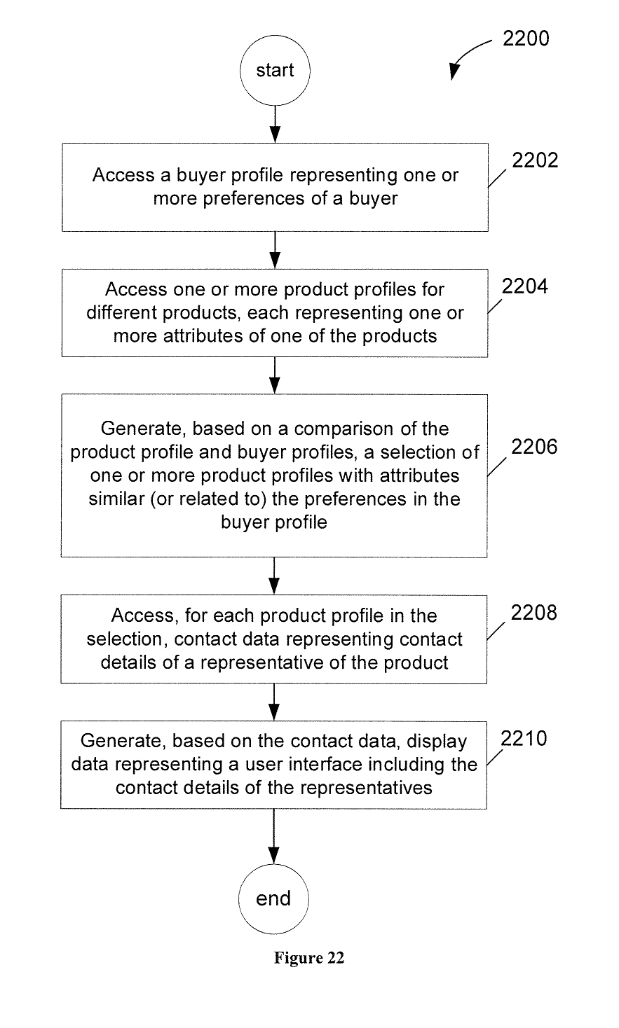

FIG. 22 shows a product to buyers matching process 2200 performed by the processing module 112 under the control of the system 100. The process 2200 identifies potential matches for a buyer with one or more products, and begins at step 2202 by the processing module 112 accessing a buyer profile representing one or more preferences of a buyer.

At step 2204, the processing module 112 accesses one or more product profiles for different products, each representing one or more attributes for one of the products.

At step 2206, the processing module 112 generates, based on a comparison of the product profile and the buyer profiles, a selection of one or more of the product profiles with attributes that are similar to (or related to) the preferences defined in the product profile.

At step 2208, the processing module 112 accesses, for each product profile in the selection, contact data representing contact details of a representative of the product.

At step 2210, the processing module 112 generates, based on the contact data, display data representing a user interface including the contact details of the representatives. Process 2200 ends after step 2210.

Some of the advantages for users using the search system 100 include:
easy-to-use user interfaces that are directly accessible via through a web browser, and provides an intuitive workspace with consistent features to enable actions be performed with minimal training. Training manuals are provided when purchasing a Licence and one-on-one training can be provided if required;
the ease of installation, which only needs to be installed once (on the server) for use/access from any location (e.g. with Internet access) from the server. The system 100 can be installed for use according to a “Lease It” model (which allows use limited to specifically nominated agencies), or on a publicly available web server 102;
There is one shared database that holds all vendor and buyer information;
The Agent's logon/username is required in the application to identify which business agency details are accessible. This maintains the confidentiality of private information of other Agents buyers and vendors listed on the database; and
The security model insures that an Agent will only see their own buyers profiles and vendor listings full details.

The search system 100 can provide a number of other advantages. The search system 100 is designed to address the fundamental challenge faced, in particular, by real estate agents. This is increasing listings. If an agent can increase listings, the resultant outcome is increased sales. Most customer facing systems available today are focused on attracting more buyers, of which the system 100 does, however, regardless of the number of buyers an agency attracts, without a good stock list of properties, sales will generally not increase by any real factor.

The search system 100 is a web-based tool that enables users to increase the ratio of property appraisals converted to listings. This is achieved by capturing aspects and features of a property at the point of appraisal and searching a national database of buyers to shortlist buyer/s that have a matching (or closely matching) buyers profile. The searchable buyers are not restricted to those of the agent, instead, all profiles of buyers registered within the system's 100 subscriber network are available for this purpose.

The agent can control how close the match is to be. The agent may chose a search scope of 10, meaning that the query shall only return results where the buyers profile is an exact match to that of the listing. Alternatively, the agent can extend the search scope out to 1, meaning that as the search expands from 10 to 1, the parameters extend to collectively include close matches.

The search results are presented to the potential vendor as a mechanism to convince the vendor to list the property with the agent. The agent and vendor can view the buyer/s profile (to qualify that the buyer is seeking a property with these attributes) and shortlist buyers that they wish to introduce to the property. To notify and subsequently introduce buyers to the particular property, the agent selects the buyer/s and shortlists the selected entities. Once shortlisted, the buyer's agent will receive an email and or text message outlining that a property has being listed that matches or closely matches their buyer (profile # 123456 . . . ). The buyer's agent receives contact details for the vendors agent and a profile of the property listed. At no time is the buyer or vendor identified to the other agent.

Another potential advantage may be an increase in the attraction rate of vendors to a real estate agency. This is achieved by providing the general market considering sell their property with a website that allows them to seek out agents that have current buyers seeking a property with their particular attributes.

When a potential vendor visits this site, they are able to undertake a basic self appraisal of their property and then select a search that will result in a list of Real estate agencies that have buyers registered who seek a property with attributes of the vendor's property. The system allows the vendor to view the profiles of each buyer (without identifying the buyer). The system provides the vendor with contact details of each agency with matching buyers. Additionally, the vendor may choose to enter their contact details into the system, and shortlist agencies that they wish to be contact by. This will generate an email/text message to the agent of each buyer shortlisted.

Yet another possible advantage may be to decrease lost sales opportunities. The system 100 attempts to address this by providing a quick method to capture desired attributes of potential buyers. This is done at initial point of contact (walk in, over the phone etc. . . . ). At the initial point of contact the agent can quickly capture the desired attributes of the buyer to build a “buyer's profile”. The agent can then perform a search for listing that match, or closely match the buyers profile. This is not limited to listings “owned” by the agency, instead it searches across all listings throughout the system's 100 agency subscriber network. Currently, agents do this in a very laborious fashion. If a buyer walks in off the street, an agent that does not have listings matching their requirement, they will manually search sites such as www.domain.com.au or www.realestate.com.au. In many instances, this will take an agent hours. SmartMatch does this in seconds, before the buyer has a chance to walk out an into a competitors agency.

Modifications and improvements to the invention will be readily apparent to those skilled in the art. Such modifications and improvements are intended to be within the scope of this invention.

The word ‘comprising’ and forms of the word ‘comprising’ as used in this description does not limit the invention claimed to exclude any variants or additions.

This application claims priority to Australian Provisional Application No. 2007-902055, the disclosure of which is incorporated herein by reference in its entirety.

### Listing 1

### Listing Type

TABLE
ListingType
Current table: none

| Field | Type | Notes |
|---|---|---|
| ListingTypeID | Integer | Serial and Primary key |
| Tname | Varchar(255) | |
| TsubPath | Varchar(255) | Subpath to the class handler. Defaults |
| | | to its name without spaces (eg Residential |
| | | Property would be ResidentialProperty) |
| Bactive | Int | Flag whether active. 0 = deleted |
| Iconid | Int | Icon for the listing |
| Nrank | Int | Order of the listing |

### Feature

TABLE
Feature
Current table: none

| Field | Type | Notes |
|---|---|---|
| FeatureID | Integer | Serial and Primary key |
| Tname | Varchar(255) | |
| nMin | Integer | Minimum number allowed in counts. Default 1 |
| Nmax | Integer | Maximum number allowed in counts. Default 1 |
| Bactive | Int | Flag whether active. 0 = deleted |

Note:
if Min and Max are both set to 1, it is understood that the feature is a one off that is included in the house.

### Area Unit

TABLE
AreaUnit
Current table: tAreaUnit

| Field | Type | Notes |
|---|---|---|
| AreaUnitID | Integer | Serial and Primary key |
| Tname | Varchar(255) | |
| Bactive | Int | Flag whether active. 0 = deleted |

### Aspect

TABLE
Aspect
Current table: tAspect

| Field | Type | Notes |
|---|---|---|
| AspectID | Integer | Serial and Primary key |
| Tname | Varchar(255) | |
| Bactive | Int | Flag whether active. 0 = deleted |

### Ceiling Type

TABLE
Ceiling Type
Current table: tCeiling

| Field | Type | Notes |
|---|---|---|
| CeilingTypeID | Integer | Serial and Primary key |
| Tname | Varchar(255) | |
| Bactive | Int | Flag whether active. 0 = deleted |

### Climate Control

TABLE
CeilingType
Current table: tClimateControl

| Field | Type | Notes |
|---|---|---|
| ClimateControlID | Integer | Serial and Primary key |
| Tname | Varchar(255) | |
| Bactive | Int | Flag whether active. 0 = deleted |

### Condition

TABLE
Condition
Current table: tCondition

| Field | Type | Notes |
|---|---|---|
| ConditionID | Integer | Serial and Primary key |
| Tname | Varchar(255) | |
| Bactive | Int | Flag whether active. 0 = deleted |

### Construction Material

TABLE
ConstructionMaterial
Current table: tConstructionMaterial

| Field | Type | Notes |
|---|---|---|
| ConstructionMaterialID | Integer | Serial and Primary key |
| Tname | Varchar(255) | |
| Bactive | Int | Flag whether active. 0 = deleted |

### Exterior Constitution

TABLE
ExteriorConstitution
Current table: tExteriorConstitution

| Field | Type | Notes |
|---|---|---|
| ExteriorConstitutionID | Integer | Serial and Primary key |
| Tname | Varchar(255) | |
| Bactive | Int | Flag whether active. 0 = deleted |

### Fence

TABLE
Fence
Current table: tFence

| Field | Type | Notes |
|---|---|---|
| FenceID | Integer | Serial and Primary key |
| Tname | Varchar(255) | |
| Bactive | Int | Flag whether active. 0 = deleted |

### Flooring

TABLE
Flooring
Current table: tFlooring

| Field | Type | Notes |
|---|---|---|
| FlooringID | Integer | Serial and Primary key |
| Tname | Varchar(255) | |
| Bactive | Int | Flag whether active. 0 = deleted |

### Frontage

TABLE
Frontage
Current table: tFrontage

| Field | Type | Notes |
|---|---|---|
| FrontageID | Integer | Serial and Primary key |
| Tname | Varchar(255) | |
| Bactive | Int | Flag whether active. 0 = deleted |

### GarageType

TABLE
GarageType
Current table: tGarage

| Field | Type | Notes |
|---|---|---|
| GarageTypeID | Integer | Serial and Primary key |
| Tname | Varchar(255) | |
| Bactive | Int | Flag whether active. 0 = deleted |

### Insulation

TABLE
Insulation
Current table: tInsulation

| Field | Type | Notes |
|---|---|---|
| InsulationID | Integer | Serial and Primary key |
| Tname | Varchar(255) | |
| Bactive | Int | Flag whether active. 0 = deleted |

### Land Contour

TABLE
LandContour
Current table: tLandContour

| Field | Type | Notes |
|---|---|---|
| LandContourID | Integer | Serial and Primary key |
| Tname | Varchar(255) | |
| Bactive | Int | Flag whether active. 0 = deleted |

### Location

TABLE
Location
Current table: tLocation

| Field | Type | Notes |
|---|---|---|
| LocationID | Integer | Serial and Primary key |
| Tname | Varchar(255) | |
| Bactive | Int | Flag whether active. 0 = deleted |
| Tsuburb | Varchar(255) | |
| StateId | Int | |
| Postcode | Varchar(10) | |
| CountryID | Int | |

### MethodOfSale

TABLE
MethodOfSale
Current table: none

| Field | Type | Notes |
|---|---|---|
| MethodOfSaleID | Integer | Serial and Primary key |
| Tname | Varchar(255) | |
| Bactive | Int | Flag whether active. 0 = deleted |
| Brental | Int | Available for Rental/Lease properties |

### Property Type

TABLE
Property Type
Current table: tResidentialListingType

| Field | Type | Notes |
|---|---|---|
| PropertyTypeID | Integer | Serial and Primary key |
| Tname | Varchar(255) | |
| Bactive | Int | Flag whether active. 0 = deleted |

New table: PropertyTypeLTListingTypeID

| Field | Type | Notes |
|---|---|---|
| PropertyTypeLTListingTypeID | Integer | Serial and Primary key |
| PropertyTypeID | int | |
| ListingTypeID | Int | |

### Region

TABLE
Region
Current table: tRegion

| Field | Type | Notes |
|---|---|---|
| RegionID | Integer | Serial and Primary key |
| Tname | Varchar(255) | |
| Bactive | Int | Flag whether active. 0 = deleted |
| StateID | Int | |
| TdisplayName | Varchar(255) | Equates to Region column in old table |
| RegionTypeID | Int | 1 = Urban, 2 = Rural, 3 = Coastal |
| | | 4 = Suburban |

### RentalStatus

TABLE
RentalStatus
Current table: tRentalStatus

| Field | Type | Notes |
|---|---|---|
| RentalStatusID | Integer | Serial and Primary key |
| Tname | Varchar(255) | |
| Bactive | Int | Flag whether active. 0 = deleted |

### ResidentialStyle

TABLE
ResidentialStyle
Current table: tResidentialStyle

| Field | Type | Notes |
|---|---|---|
| ResidentialStyleID | Integer | Serial and Primary key |
| Tname | Varchar(255) | |
| Bactive | Int | Flag whether active. 0 = deleted |

### Roof

TABLE
Roof
Current table: tRoof

| Field | Type | Notes |
|---|---|---|
| RoofID | Integer | Serial and Primary key |
| Tname | Varchar(255) | |
| Bactive | Int | Flag whether active. 0 = deleted |

### RoomFeature

TABLE
RoomFeature
Current table: none

| Field | Type | Notes |
|---|---|---|
| RoomFeatureID | Integer | Serial and Primary key |
| Tname | Varchar(255) | |
| Bactive | Int | Flag whether active. 0 = deleted |

### MeasurementUnit

TABLE
MeasurementUnit
Current table: none

| Field | Type | Notes |
|---|---|---|
| MeasurementUnitID | Integer | Serial and Primary key |
| Tname | Varchar(255) | |
| Bactive | Int | Flag whether active. 0 = deleted |

TABLE
RoomType
Current table: tRoomType

| Field | Type | Notes |
|---|---|---|
| RoomTypeID | Integer | Serial and Primary key |
| Tname | Varchar(255) | |
| Bactive | Int | Flag whether active. 0 = deleted |

SaleStatus

TABLE
SaleStatus
Current table: tSaleStatus

| Field | Type | Notes |
|---|---|---|
| SaleStatusID | Integer | Serial and Primary key |
| Tname | Varchar(255) | |
| Bactive | Int | Flag whether active. 0 = deleted |
| Brental | Int | Applies to rental properties |
| Bsales | Int | Applies to sale properties |

### State

TABLE
State
Current table: tState

| Field | Type | Notes |
|---|---|---|
| StateID | Integer | Serial and Primary key |
| Tname | Varchar(255) | Old Table: Noun |
| Bactive | Int | Flag whether active. 0 = deleted |
| Tcode | Varchar(255) | Old Table: State |
| CountryID | Int | |

### VendorSource

TABLE
VendorSource
Current table: tVendorSource

| Field | Type | Notes |
|---|---|---|
| VendorSourceID | Integer | Serial and Primary key |
| Tname | Varchar(255) | |
| Bactive | Int | Flag whether active. 0 = deleted |

### ViewType

TABLE
ViewType
Current table: tViewType

| Field | Type | Notes |
|---|---|---|
| ViewTypeID | Integer | Serial and Primary key |
| Tname | Varchar(255) | |
| Bactive | Int | Flag whether active. 0 = deleted |

### Listing 2

Current Table: TxBusiness
SmartMatch Name: Business

| Field | New Name | Comments |
|---|---|---|
| BusinessID | | |
| Active | Bactive | |
| Address1 | AddressID | Combine all address fields into the |
| | | Address table. |
| Address2 | AddressID | |
| Address3 | AddressID | |
| AllowedBusinessSessions | NallowedBusinessSessions | |
| ApplicationID | [Ignore] | |
| Business | Tname | |
| BusinessIdentifier | Tidentifier | |
| City | AddressID | |
| CorporateImage | TcorporateImage | Filename of stored image |
| CountryID | AddressID | |
| Created | Dcreated | |
| Deleted | Ddeleted | |
| Email | Temail | |
| Fax | AddressID | |
| LanguageID | LanguageID | Default to 1 (English), but largely |
| | | ignored |
| Phone | AddressID | |
| Postcode | AddressID | |
| ShortListEmail | BshortListEmail | |
| ShortListSMS | BshortListSMS | |
| SkinID | TemplateID | Ignore for now, but will apply to |
| | | templates for Window Cards |
| State | AddressID | |
| UpdateNum | [Ignore] | |
| UpdateUserID | SecurityUserID | |
| Updated | Dupdated | |
| | SecurityUserTypeID | New field to add with SecurityUserID |

### Listing 3

Current Table: TxBusiness User
SmartMatch Name: BusinessUser

| Field | New Name | Comments |
|---|---|---|
| BusinessUserID | BusinessUserID | |
| BusinessID | BusinessID | Link to |
| | | Business.BusinessID |
| BusinessUser | [Ignore] | |
| Created | Dcreated | |
| Deleted | Ddeleted | |
| ReceiveEmail | BreceiveEmail | |
| RoleID | [Ignore] | |
| UpdateNum | [Ignore] | |
| UpdateUserID | UpdateUserID | |
| Updated | Dupdated | |
| UserID | SecurityUserID | |
| | SecurityUserTypeID | What kind of user is this |
| | | linked to |
| | Bdefault | Flag this business as the |
| | | user's default |
| | UpdateSecurityUserTypeID | |

### Listing 4

Current Table: TxUser
SmartMatch Name: User

| Field | New Name | Comments |
|---|---|---|
| UserID | UserID | |
| BusinessID | [Ignore] | |
| Active | Bactive | |
| AgreementAccepted | BagreementAccepted | |
| AgreementDate | Dagreement | |
| AllowedUserSessions | NallowedUserSessions | |
| AuditAllStoredProcs | [Ignore] | |
| AuditAllTriggers | [Ignore] | |
| Created | Dcreated | |
| DateOfBirth | DDOB | |
| DefaultBusinessID | [Ignore] | Was used for default |
| | | business |
| Deleted | Ddeleted | |
| Email | Temail | |
| ErrorSeverityFilter | [Ignore] | |
| Fax | Tfax | |
| FirstName | TfirstName | |
| LastLoginAttempt | DlastLoginAttempt | |
| LastName | TlastName | |
| LoginAttempts | NloginAttempts | |
| Mobile | Tmobile | |
| Password | Tpassword | |
| PasswordExpires | DpasswordExpires | |
| PasswordNeverExpires | BpasswordNeverExpires | |
| Phone | Tphone | |
| SecurityAnswer | TsecurityAnswer | |
| SecurityQuestion | TsecurityQuestion | |
| Title | Ttitle | |
| UpdateNum | [Ignore] | |
| UpdateUserID | SecurityUserID | |
| Updated | Dupdated | |
| User | [Ignore] | |
| UserName | TuserName | |
| | SecurityUserTypeID | Link the update to a |
| | | real user |

### Listing 5

TABLE
Template

| Field | Type | Notes |
|---|---|---|
| TemplateID | Int | Primary key |
| Tname | Varchar(255) | |
| TheaderFile | Varchar(255) | Header HTML file |
| TfooterFile | Varchar(255) | Footer HTML file |
| Tprocessor | Varchar(255) | Processor file (usually tName without |
| | | spaces or punctuation) |
| Bactive | Int | Whether it is available or not |
| TCSSFile | Varchar(255) | Stylesheet to control colours/fonts |

TABLE
TemplateLTBusiness
Purpose: This table allows specific features to be updated by the agency
to influence the look. This is mainly the style sheet, and the logo
files. For the Beta version, this should only be available to Sys Admins.

| Field | Type | Notes |
|---|---|---|
| TemplateLTAgencyID | Int | |
| TemplateID | Int | |
| BusinessID | Int | |
| TCSSFile | Varchar(255) | |
| TlogoFile | Varchar(255) | |

### Listing 6

TABLE
StakeholderType

| Field | Type | Notes |
|---|---|---|
| StakeholderTypeId | Int | Primary key |
| Tname | Varchar(255) | Name of the stakeholder type (eg |
| | | Agent) |
| Nrank | Int | Order to display in app menu |
| IconID | Int | Link to appropriate icon |
| TsubPath | Varchar(255) | Name of path to the specific files |
| | | for it |
| Bactive | Int | 1 = active, 0 = inactive |

### Listing 7

TABLE
Stakeholder

| Field | Type | Notes |
|---|---|---|
| StakeholderID | Int | Primary key |
| StakeholderTypeId | Int | Its type |
| TfirstName | Varchar(255) | |
| TlastName | Varchar(255) | |
| TfullName | Varchar(255) | This is either a calculated |
| | | field using the combination of |
| | | first and last name, or it is |
| | | a separate field for business |
| | | name, depending on the type |
| AddressID | Int | This links to an address |
| | | record, which contains |
| | | address (lines 1-4), suburb, |
| | | state, postcode, phone number, |
| | | fax number, email address, |
| | | web address, mobile phone |
| SecurityuserID | Int | User who last modified the |
| | | stakeholder |
| SecurityUserTypeID | Int | Type of user who last |
| | | modified the stakeholder |
| | | (Agency user, Sys admin |
| | | etc) |
| Dupdate | Datetime | Date/time of last change |
| Dcreated | Datetime | Date/time it was added |
| Bactive | Int | 1 = active, 0 = inactive |
| | | (deleted) |
| BusinessID | Int | Which agency was this |
| | | information entered by and |
| | | apply to? |
| BprivacyConsentSigned | Int | Boolean - 1 = yes, 0 = no |

### Listing 8

File Setup

| File | Description |
|---|---|
| List.cfm | Controls the listing frameset |
| ListBody.cfm | Main body of the page - includes view/edit/delete |
| ListToolbar.cfm | Toolbar of the page - includes add/search features |
| Detail.cfm | On clicking “View” it goes to this page, controls |
| | the frameset |
| DetailToolbar.cfm | Shows various “tabs” that apply to stakeholders |
| Summary.cfm | Main view of stakeholder, showing all info and |
| | link to “Edit” |
| Actions.cfm | Standard XMLRPC file to control the flow of data |
| | read/write |
| Modify.cfm | Modify “wrapper” which will call in objects from |
| | the sub-paths for individual stakeholders, allowing |
| | custom form displays for each one |

### Listing 9

TABLE
BuyerProfile

| Field | Type | Notes |
|---|---|---|
| BuyerProfileId | Int | Primary key |
| BuyerID | Int | |
| Bactive | Int | |
| Tname | Varchar(255) | |
| Dprofile | Datetime | |
| PropertyTypeID | Int | |
| ListingTypeID | Int | |
| NminPrice | Varchar(255) | |
| NmaxPrice | Varchar(255) | |
| SuburbID | Int | |
| BsurroundingSuburbs | Int | |
| NsearchScope | Int | |
| Bpool | Int | |
| BclimateControl | Int | |
| TlandSize | Varchar(255) | |
| LandAreaUnitId | Int | |
| NKMToAmenities | Int | |
| NweeklyInvestmentReturn | Varchar(255) | |
| Dchange | Datetime | |
| SecurityUserID | Int | |
| SecurityUserTypeID | Int | |
| TsubType | Varchar(255) | (eg Rental, For Sale etc) |

TABLE
BuyerProfileRoom

| Field | Type | Notes |
|---|---|---|
| BuyerProfileRoomID | Int | Primary key |
| BuyerProfileId | Int | |
| RoomTypeId | Int | |
| Ncount | Int | |

TABLE
BuyerProfileFeature

| Field | Type | Notes |
|---|---|---|
| BuyerProfileRoomID | Int | Primary key |
| BuyerProfileId | Int | |
| FeatureId | Int | |
| Ncount | Int | |

### Listing 10

TABLE
ListingType

| Field | Type | Notes |
|---|---|---|
| ListingTypeId | Int | Primary key |
| Tname | Varchar(255) | Name of the listing type (eg Residential) |
| Nrank | Int | Order to display in app menu |
| IconID | Int | Link to appropriate icon |
| TsubPath | Varchar(255) | Name of path to the specific files for it |
| Bactive | Int | 1 = active, 0 = inactive |

### Listing 11

File Setup

| File | Description |
|---|---|
| List.cfm | Controls the listing frameset |
| ListBody.cfm | Main body of the page - includes view/edit/ |
| | delete |
| ListToolbar.cfm | Toolbar of the page - includes add/search |
| | features |
| Detail.cfm | On clicking “View” it goes to this page, |
| | controls the frameset |
| DetailToolbar.cfm | Shows various “tabs” that apply to listings |
| Summary.cfm | Main view of listing, showing general info and |
| | link to “Edit” |
| Actions.cfm | Standard XMLRPC file to control the flow of |
| | data read/write |
| Modify.cfm | Modify “wrapper” which will call in objects |
| | from the sub-paths for individual listings, |
| | allowing custom form displays for each one |

### Listing 12

### Type: All

TABLE
Listing

| Field | Type | Notes |
|---|---|---|
| ListingID | Int | Primary key |
| ListingTypeId | Int | Its type |
| TsubType | Varchar(255) | Options: For Sale, For |
| | | Rent, Share, OffPlan, |
| | | For Lease, Rural etc |
| Tname | Varchar(255) | Combination of address, |
| | | vendor and date of |
| | | listing |
| AddressID | Int | This links to an address |
| | | record, which contains |
| | | address (lines 1-4), |
| | | suburb, state, postcode, |
| | | phone number, fax number, |
| | | email address, web |
| | | address, mobile phone |
| SecurityuserID | Int | User who last modified |
| | | the listing |
| SecurityUserTypeID | Int | Type of user who last |
| | | modified the listing |
| | | (Agency user, Sys |
| | | admin etc) |
| Dupdate | Datetime | Date/time of last change |
| Dcreated | Datetime | Date/time it was added |
| Bactive | Int | 1 = active, 0 = inactive |
| | | (deleted) |
| Tcomments | Text | Free text field |
| TspecialConditions | Text | Free text field |
| NListPrice | Varchar(255) | Listing price |
| nContractPrice | Varchar(255) | |
| MethodOfSaleId | Int | |
| VendorID | Int | |
| Dlisting | Datetime | Date of listing |
| DlistingExpires | Datetime | Date listing expires |
| NrentPerWeek | Varchar(255) | Rent price - used for |
| | | sale, rent and share |
| Nfloors | Int | |
| Tlevel | Varchar(255) | Options: Above Road, |
| | | Below Road, Ground |
| | | Level |
| NinteriorCondition | Int | (1 = Poor, 5 = Excellent) |
| FlooringID | Int | |
| CeilingTypeId | Int | |
| InsulationID | Int | |
| ExteriorConstitutionID | Int | |
| NexteriorCondition | Int | (1 = Poor, 5 = Excellent) |
| BkeysInOffice | Int | |
| Property TypeID | Int | Residential Listing Type |
| | | in the system 100 |
| BusinessID | Int | Linked to the agency |
| TlandArea | Varchar(255) | |
| LandAreaUnitID | Int | |
| TbuildingArea | Varchar(255) | |
| BuildingAreaUnitID | Int | |
| TlocalAuthority | Varchar(255) | |
| Tzone | Varchar(255) | |
| Tlot | Varchar(255) | |
| Trates | Varchar(255) | |
| NleaseAmount | Varchar(255) | |
| DleaseExpires | Datetime | |
| Tlessor | Varchar(255) | |
| BunderConstruction | Int | |
| Tage | Varchar(255) | Age of the property |
| TlegalComments | Text | |
| Tholding | Varchar(255) | Options: Full, Part |
| TRP | Varchar(255) | RP - what is this? |
| TSP | Varchar(255) | SP - what is this? |
| | | Sale Price? |
| TCP | Varchar(255) | CP - what is this? |
| | | Contract price? |
| Tremarks | Text | General comments |
| TadvertisementCopy | Text | |
| TconfidentialComments | Text | Only visible by Agency |
| | | users and can not be |
| | | shown to buyers |
| Dauction | Datetime | |
| TauctionLocation | Varchar(255) | |
| TauctionNotes | Text | |
| ListingHistoryID | Int | Links to latest history |
| | | item for this listing, |
| | | covering the salestatus |
| BvendorIsContact | Int | |
| VendorSolicitorID | Int | |
| ContactID | Int | This is an AddressID |
| | | of the contact, where |
| | | it is not the Vendor. |
| Dcontract | Datetime | Date of contract |
| DsettlementDue | Datetime | |
| Dsettlement | Datetime | Actual settlement |
| Dfallover | Datetime | |
| TfalloverReason | Text | |
| BuyerSolicitorID | Int | |

### Type: All

TABLE
ListingHistory

| Field | Type | Notes |
|---|---|---|
| ListingHistoryID | Int | |
| ListingID | Int | |
| SaleStatusID | Int | |
| Dchange | Datetime | |
| BvendorConsent | Int | |
| BprincipalApproval | Int | |
| NsalePrice | Varchar(255) | |
| NvendorCommission | Varchar(255) | |
| NbuyerAgentCommission | Varchar(255) | |
| SecurityUserID | Int | |
| SecurityUserTypeID | Int | |

Note:
this keeps track of changes to the sales status of the property

### Type: all

TABLE
ListingCondition

| Field | Type | Notes |
|---|---|---|
| ListingConditionID | Int | |
| ListingID | Int | |
| Tcondition | Varchar(255) | Options: Building & Pest |
| | | Inspection, Finance Approval, |
| | | Other |
| TconditionOther | Varchar(255) | More detail |
| Ddue | Datetime | Due date |
| Dactual | Datetime | Actual date |

### Type: All

TABLE
ListingFeature

| Field | Type | Notes |
|---|---|---|
| ListingFeatureID | Int | |
| ListingID | Int | |
| FeatureID | Int | |
| Ncount | Int | |
| TfeatureType | Varchar(255) | This is for Other Feature 1, 2 . . . n |

Note:
this is equivalent to Chattels

### Type: All

TABLE
ListingRoom

| Field | Type | Notes |
|---|---|---|
| ListingRoomID | Int | |
| ListingID | Int | |
| RoomTypeID | Int | |
| FlooringID | Int | |
| Tdescription | Varchar(255) | Eg, Bedroom 1, Master Bedroom |
| TfloorSpace | Varchar(255) | |

### Type: All

TABLE
ListingRoomFeature

| Field | Type | Notes |
|---|---|---|
| ListingRoomFeatureID | Int | |
| ListingRoomID | Int | |
| RoomFeatureID | Int | |

### Type: All

TABLE
ListingPhoto

| Field | Type | Notes |
|---|---|---|
| ListingRoomID | Int | |
| ListingID | Int | |
| Timage | Varchar(255) | Full size photo filename |
| TthumbnailImage | Varchar(255) | Thumbnail photo filename |
| ListingRoomID | Int | Optional - links photo to a room in the |
| | | listing |
| Tcaption | Text | Description of photo |
| Nrank | Int | Order of photo |
| Bcontent | Int | Photo used for content (window card, |
| | | realestate.com.au etc) |

### Type: All

TABLE
ListingShortlist

| Field | Type | Notes |
|---|---|---|
| ListingShortlistID | Int | |
| ListingID | Int | |
| BuyerProfileId | Int | Link to the buyer's profile |
| SecurityUserID | Int | Who added them? |
| SecurityUserTypeID | Int | What type was the who? |
| Dchange | Datetime | Date it last changed |
| Bactive | Int | Are they currently on the shortlist, or |
| | | removed? |
| Tcomments | Text | Comments about this buyer? |

### Type: All

TABLE
ListingAction
Description: This lists the things that can happen with a listing.
Such actions include: Listed, Sold, Leased,
Withdrawn, Deleted, Updated, Uploaded

| Field | Type | Notes |
|---|---|---|
| ListingActionID | Int | |
| ListingID | Int | |
| ActionTypeID | Int | Link to the buyer's profile |
| SecurityUserID | Int | Who did the action |
| SecurityUserTypeID | Int | What type was the who? |
| Daction | Datetime | Date it changed |

### Type: All

TABLE
ActionType

| Field | Type | Notes |
|---|---|---|
| ActionTypeID | Int | |
| Tname | Varchar(255) | |
| Bfinish | Int | Does this action “kill” the listing |

### Type: Residential

TABLE
ResidentialListing

| Field | Type | Notes |
|---|---|---|
| ResidentialListingID | Int | Primary key |
| ListingID | Int | Listing |
| ResidentialStyleID | Int | |
| GarageTypeID | Int | |
| ClimateControIID | Int | |
| TswimmingPool | Varchar(255) | Options: Above Ground, In |
| | | Ground, Spa |
| Thotwater | Varchar(255) | Options: Gas, Electric, Solar |
| Tstove | Varchar(255) | Options: Bottled, Reticulated, |
| | | Electric |
| Tjoinery | Varchar(255) | Options: Aluminium, Wood |
| FenceID | Int | |
| RoofID | Int | |
| ViewTypeID | Int | |
| AspectID | Int | |
| FrontageID | Int | |
| LandContourID | Int | |
| ExteriorConstitutionID | Int | |
| Tsewage | Varchar(255) | Options: City, Tank |
| TwaterSupply | Varchar(255) | Options: City, Tank, Dam, Bore |

### Type: Commercial

TABLE
Commercial
Additional fields may be included.

| Field | Type | Notes |
|---|---|---|
| CommercialID | Int | Primary key |
| ListingID | Int | |
| TpercentageReturn | Varchar(255) | Frontage in Metres |
| TfloorArea | Varchar(255) | Floor area, square metres |
| Tauthority | Varchar(255) | Options: Auction, EOI, Sale by |
| | | Negotiation, Tender |

### Type: Vacant Land

TABLE
VacantLand

| Field | Type | Notes |
|---|---|---|
| VacantLandID | Int | Primary key |
| ListingID | Int | |
| TfrontageSize | Varchar(255) | Frontage in Metres |

1-16. (canceled)

17. A profile-based search system for identifying potential matches for a product with one or more buyers, the system including at least one processor configured to:
access a product profile representing one or more attributes of a product;
access one or more buyer profiles for different buyers, each representing one or more preferences for one of said buyers;
generate, based on a comparison of said product profile and said buyer profiles, a selection of one or more of said buyer profiles with preferences that are similar to the attributes defined in said product profile;
access, for each said buyer profile in said selection, contact data representing contact details of a representative of said buyer; and
generate, based on said contact data, display data representing a user interface including the contact details of said representatives.

18. A system as claimed in claim 17, wherein said one or more buyer profiles are selected based on the value of a preference parameter in each of said buyer profiles containing an exact match a corresponding attribute parameter in said product profile.

19. A system as claimed in claim 17, wherein said one or more buyer profiles are selected based on the value of a preference parameter in each of said buyer profiles falling within a predetermined range of the corresponding attribute parameter in said product profile.

20. A system as claimed in claim 17, wherein said contact details include at least one of a telephone number, postal address, email address and network address.

21. A system as claimed in claim 17, wherein said product is real property, and said attributes represent physical properties of said real property.

22. A profile-based search system for identifying potential matches for a buyer with one or more products, the system including at least one processor configured to:
access a buyer profile representing one or more preferences of a buyer;
access one or more product profiles for different products, each representing one or more attributes for one of said products;
generate, based on a comparison of said product profile and said buyer profiles, a selection of one or more of said product profiles with attributes that are similar to the preferences defined in said product profile;
access, for each said product profile in said selection, contact data representing contact details of a representative of said product; and
generate, based on said contact data, display data representing a user interface including the contact details of said representatives.

23. A system as claimed in claim 22, wherein said one or more buyer profiles are selected based on the value of a preference parameter in each of said buyer profiles containing an exact match a corresponding attribute parameter in said product profile.

24. A system as claimed in claim 22, wherein said one or more buyer profiles are selected based on the value of a preference parameter in each of said buyer profiles falling within a predetermined range of the corresponding attribute parameter in said product profile.

25. A system as claimed in claim 22, wherein said contact details include at least one of a telephone number, postal address, email address and network address.

26. A system as claimed in claim 22, wherein said product is real property, and said attributes represent physical properties of said real property.

27. A profile-based search method for identifying potential matches for a product with one or more buyers, including:
accessing a product profile representing one or more attributes of a product;
accessing one or more buyer profiles for different buyers, each representing one or more preferences for one of said buyers;
generating, based on a comparison of said product profile and said buyer profiles, a selection of one or more of said buyer profiles having preferences that are similar to the attributes defined in said product profile;
accessing, for each said buyer profile in said selection, contact data representing contact details of a representative of said buyer; and
generating, based on said contact data, display data representing a user interface including the contact details of said representatives.

28. A system as claimed in claim 27, wherein said one or more buyer profiles are selected based on the value of a preference parameter in each of said buyer profiles containing an exact match a corresponding attribute parameter in said product profile.

29. A system as claimed in claim 27, wherein said one or more buyer profiles are selected based on the value of a preference parameter in each of said buyer profiles falling within a predetermined range of the corresponding attribute parameter in said product profile.

30. A system as claimed in claim 27, wherein said contact details include at least one of a telephone number, postal address, email address and network address.

31. A system as claimed in claim 27, wherein said product is real property, and said attributes represent physical properties of said real property.

32. A profile-based search method for identifying potential matches for a buyer with one or more products, including:
accessing a buyer profile representing one or more preferences of a buyer;
accessing one or more product profiles for different products, each representing one or more attributes for one of said products;
generating, based on a comparison of said product profile and said buyer profiles, a selection of one or more of said product profiles having attributes that are similar to the preferences defined in said product profile;
accessing, for each said product profile in said selection, contact data representing contact details of a representative of said product; and
generating, based on said contact data, display data representing a user interface including the contact details of said representatives.

33. A system as claimed in claim 32, wherein said one or more buyer profiles are selected based on the value of a preference parameter in each of said buyer profiles containing an exact match a corresponding attribute parameter in said product profile.

34. A system as claimed in claim 32, wherein said one or more buyer profiles are selected based on the value of a preference parameter in each of said buyer profiles falling within a predetermined range of the corresponding attribute parameter in said product profile.

35. A system as claimed in claim 32, wherein said contact details include at least one of a telephone number, postal address, email address and network address.

36. A system as claimed in claim 32, wherein said product is real property, and said attributes represent physical properties of said real property.

37. A real estate search system for identifying a potential market for a property, said system being configured to:
store, for one or more buyers, buyer profile data representing the preferences of each of said buyers;
store, for one or more real properties, property profile data representing the attributes of each of said properties; and
generate, based on a comparison of said buyer profile data and said property profile data, a selection representing a potential market for a selected one of said properties, said selection including one or more of said buyers with preferences similar to the attributes for said selected property.

38. A system as claimed in claim 37 further configured to generate a price value for said selected property based on the size of said potential market.

39. A system as claimed in claim 37, wherein said property profile data includes seller identification data representing a representative for selling said property, and said system is further configured to generate, based on said comparison, a selected one or more of said representatives having a larger said potential market for said selected property.

40. A computer implemented method for identifying a potential market for a real property, comprising the steps of:
storing, for each of a plurality of buyers, buyer profile data representing desired property characteristics for property that said buyer would like to purchase;
inputting, by a potential seller, property profile data representing property characteristics for a property owned by the potential seller that the potential seller would like to sell; and
generating and outputting, based on a comparison of each of said buyer profile data and said property profile data, a selection representing a potential market for the property owned by the potential seller, said selection including identification of one or more of said buyers with preferences similar to the attributes for said selected property.
